(19) United States
(12) Patent Application Publication
(10) Pub. No.: US 2016/0006629 A1
(43) Pub. Date: Jan. 7, 2016

(54) APPLIANCE CLEARINGHOUSE WITH ORCHESTRATED LOGIC FUSION AND DATA FABRIC - ARCHITECTURE, SYSTEM AND METHOD

(71) Applicants: George Ianakiev, Chevy Chase, MD (US); Hristo Trenkov, Rockville, MD (US)

(72) Inventors: George Ianakiev, Chevy Chase, MD (US); Hristo Trenkov, Rockville, MD (US)

(21) Appl. No.: 14/324,221

(22) Filed: Jul. 6, 2014

(51) Int. Cl. H04L 12/26; G06F 17/30

(52) U.S. Cl. CPC H04L 43/08; G06F 17/30091

(57) ABSTRACT

A computerized method for controlling or connecting a plurality of computer appliances in a networked control system comprised of control center, computer appliance and peripherals for the purposes of establishing an automated framework and technical devices for intelligent integration of two or more applications, logic rules, data repositories and/or services together to automate, manage, synchronize or monitor knowledge or business solutions in real-time. The control center, computer appliances or peripherals can store and process structured or unstructured data; the control center is communicating with each appliance or periphery across a communication network; the control center can determine when an appliances or peripheral requires maintenance or update; the control center controls the current inventory of computer appliances and peripherals; the control center can add or reinitialize a new computer appliance or peripheral; the computer appliance can also add peripherals. A user can interact with the control center, computer appliance or a peripheral to perform monitoring, management or analysis functions.

### CROSS REFERENCE TO RELATED PROVISIONAL APPLICATION

This application claims the benefit of U.S. Provisional Patent Application No. 61/843,430 filed on Jul. 7, 2013, the disclosure of which is hereby incorporated herein by reference in its entirety.

### COPYRIGHT NOTICE

Portions of the disclosure of this document contain materials that are subject to copyright protection. The copyright owner has no objection to the facsimile reproduction of the patent document or patent disclosure as it appears in the U.S. Patent and Trademark Office patent files or records solely for use in connection with consideration of the prosecution of this patent application, but otherwise reserves all copyright rights whatsoever.

### FIELD OF THE INVENTION

The present invention generally relates to cross-functional, cross-industry logic methods and technology-enabled infrastructure to facilitate the orchestration and integration of data and logic fusion. More particularly, the present invention provides an automated framework and technical devices for intelligent integration of two or more applications, logic rules, data repositories and/or services together to automate, manage, synchronize or monitor knowledge or business solutions in real-time.

### BACKGROUND OF THE INVENTION

In 2010, Google's Eric Schmidt said that “I don't believe society understands what happens when everything is available, knowable and recorded by everyone all the time.” He was referring to the fact that in the digital world, data are everywhere. We create them constantly, often without our knowledge or permission, and with the bytes we leave behind, we leak information about our actions, whereabouts, characteristics, and preferences.

This revolution in sensemaking—in deriving value from data—is having a profound and disruptive effect on all aspects of business from competitive advantage to advantage in an intelligent adversary situation. Simply put, with so much data available to the organizations, in both public social networks and internally generated, the ability to gain a competitive edge has never been greater and more necessary.

As usable data expands exponentially, the cost of reconfiguring systems to handle that data will increase exponentially. The rising cost of data management will make it harder to compete in a global economy with fewer capital investments. Inversely to stay competitive, larger capital investments into data system infrastructure will be needed. This rising cost of acquiring more and more useable data impedes business growth and prevents smaller enterprises from implementing such data systems ^{[1]}.

If larger amounts of data can be harnessed and used in a more cost-efficient manner, then a business or organization will have a leg up compared to its competitors. More sophisticated and streamlined programs will be needed to manage this data.

Despite many organizations having already developed capabilities to derive quality from the vast quantity of available data, the next big data revolution has yet to happen in full strength thanks in large part to mobile devices. If you think of mobile devices as sensors, our phones, and tablets know more about us than any human being. Increasing integration of hardware and software (in the form of apps) systems in mobile devices will generate increasing amounts of novel data. To deal with this large influx and very valuable data, innovative systems and approach are needed to integrate, catalog, and make useable the disparate data.

This presents organizations with the “Big Data Dilemma”—where the more information is harvested and available to the Organizations, the harder it is to derive actionable and purposeful value within reasonable time, cost, and risk. In 2007, 85% of all data is in an unstructured format ^{[2]}, which is to say that it has not been cataloged and made readily available for businesses and organizations to utilize easily. This number is growing as the capacity of conventional data collection surpasses the capacity for organizing that data. To make this wealth of data more usable, new technologies and methods are going to be required to describe the data ontologically. New software and hardware implementations will allow for the integration and subsequent retrieval of data. While acquiring data across different media, systems will need to be able to integrate data structured and stored in discrepant and isolated systems. Big Data has become so voluminous that it is no longer feasible to manipulate and move it all around. The data will be organized ontologically in ways to facilitate management of these data systems. These organizations will allow relevant data to be identified and retrieved easily, allowing data to be manipulated and analyzed. This will streamline the process by reducing operation time and cost, which are major sources of expenditures for organizations ^{[3]}.

Development of such systems to organize data is a highly repeatable process, but a standard toolset does not exist. The absence of such a system causes businesses and organizations to reinvent how data should be integrated in place of focusing on core market activities ^{[3]}. Reproducing data systems and constant adaptation of the development of data systems, will allow businesses or organizations to adopt higher quality and lower risk data systems at a lower price.

Data integration risks are often significant due to potential loss or unauthorized access of proprietary data. To ensure that such data will not be compromised, many organizations are in need of physical separation between themselves and the sources of the data. This will make it easier for companies to extract data while complying with legal regulations (for example), which will reduce cost ^{[3]}.

The present invention solves the above-identified problems via various novel approaches to architect data and logic orchestration fusion platform based on managed or non-managed technical algorithms, software programs and hardware appliances.

1. http://www.wallstreetandtech.com/data-management/technology-economics-the-cost-of-data/231500503

2. http://www.forbes.com/2007/04/04/teradata-solution-software-biz-logistics-cx_rm 0405data.html

3. http://www.forbes.com/2010/10/08/legal-security-requirements-technology-data-maintenance.html

### SUMMARY OF THE INVENTION

The system described in the present invention is a collective of Master Appliance(s), Slave Appliance(s), and Peripheral(s) in order to facilitate the acquisition and management of data so that it can be made useable by organizations to support operations and guide actions. Data are standardized from different sources so that comprehensive and accurate data models can be produced. Slave appliances collect data from disparate sources, and their products are relayed to the master appliance, which coordinates the data mining and analysis operations. Users manage the system through the master appliance. Users also can interact with all components of the system to perform various instructions and logical operations. This data can be fed to external programs (such as TRIZ-based Problem Extractor and Solver systems) in order to determine specific courses of action for business or organizational problems.

### BRIEF DESCRIPTION OF THE DRAWINGS

For a fuller understanding of the invention, reference is made to the following description taken in connection with the accompanying drawings in which:

FIG. 1: Depicts the deployment architecture diagram of a managed master-slave deployment with a slave Appliance that collects data from Peripheral devices and submits it to the Master appliance for processing.

FIG. 2: Depicts the deployment architecture of a managed federated deployment where multiple Autonomous Appliances collect data from peripheral devices. Collected data is federated and submitted to the Master appliance for processing.

FIG. 3: Depicts the deployment architecture of an Autonomous Appliance that collects data from multiple peripheral devices.

FIG. 4: Depicts the architecture of the Management Console Data Integration layer.

FIG. 5: Depicts the processing and transmission of instructions posted to Appliances (distributed slave nodes).

FIG. 6: Depicts one-way master-slave architecture, comprised of six processing chain steps: (1) origination, (2) verification, (3) staging, (4) task pull, (5) security, and (6) execution.

FIG. 7: Depicts two-way master-slave architecture, comprised of six processing chain steps: (1) origination, (2) verification and receipt, (3) staging, (4) task pull, (5) security, and (6) execution and receipt/response.

FIG. 8: Depicts the processing and transmission of data posted to the Management Console Appliances.

FIG. 9: Depicts one-way master-slave interactions between the Appliance and the Management Console, comprised of six processing chain steps: (1) origination, (2) verification, (3) staging, (4) task pull, (5) security, and (6) execution.

FIG. 10: Depicts a snapshot of the features of the GUI of one representative embodiment.

FIG. 11: Depicts the Business Intelligence layer which is componentized, modular and scalable; the BI architecture is organized in five levels: presentation, analytics, logic, data and integration, and 3rd party application layer.

FIG. 12: Depicts the common Appliance architecture, which is organized in three areas: application services, core services, and support services.

FIG. 13: Depicts the architecture of the Appliance Data Integration layer.

FIG. 14: Depicts the processing and transmission of data posted from the Management Console.

FIG. 15: Depicts the processing and transmission of data posted to the Management Console.

FIG. 16: Depicts the master-slave interactions between the Appliance and the Management Console; they are only one way and can trigger a PULL instruction to be generated from the Management Console to the Appliance. Comprised of six steps: (1) origination, (2) verification, (3) staging, (4) task pull, (5) security, and (6) execution.

FIG. 17: Depicts the Processing Chain—Instructions to Peripheral (pull mode). This processing chain is similar to how the Management Console sends instructions to the Appliances.

FIG. 18: Depicts the Processing Chain—Receiving and Processing data from peripheral (push model). This processing chain is similar to how the Management Console receives instructions to the Appliances.

FIG. 19: Depicts the mobile peripheral architecture of a peripheral which can be a mobile device—Tablet or smartphone running mobile operating system and connected to an Appliance either directly or over Cloud.

FIG. 20: Depicts the wearable computer architecture of a Peripheral which can also be a wearable computer with a head-mounted display.

FIG. 21: Depicts the Processing Chain—Instructions from Appliance (pull model). This processing chain is similar to how the Management Console sends instructions to the Appliances.

FIG. 22: Depicts the Processing Chain—Processing and Submitting data to Appliance (push model). This processing chain is similar to how the Management Console receives instructions from Appliances.

FIG. 23: Depicts the data fusion concept, comprising of social media and federated threat data, management console with reference data and threat data, appliance(s) with inputs and outputs, and peripherals and active asset collector(s).

FIG. 24: Depicts the concept of a business has a specific problem to address (Input Data); problem is then matched to business taxonomies that abstract the problem; abstract problem is then fed to the pattern driven master hub (Logic Fusion) that provides an abstract solution; Abstract solution is then mapped to Definitional Taxonomies that provide a specific solution.

FIG. 25: Depicts the finding an ideal solution to address a contradiction. Logic Fusion represents the contradiction matrix, which provides a systematic access to most relevant subset of inventive principals depending on the type of a contradiction.

FIG. 26: Depicts how analysis and decisions of business patterns is defined in a public hub containing domain specific solutions, informed by external to the organization public data. Private instances of the public hub are then created for each specific Organizational purposes, allowing private to the Organization data to be added into the analysis and decisions processes.

FIG. 27: Depicts the four use cases described in the example.

FIG. 28: Depicts a functional architecture of the present invention deployed as an Identity Clearinghouse for the Transportation Security Agency (TSA) airport security. This implementation of the present invention is based on a secured clearinghouse implementation.

### DETAILED DESCRIPTION OF THE PREFERRED EMBODIMENTS

### Use Cases

This section describes, for illustrative purposes, applications of the present invention:

Use Case: Data Fusion—Intelligence community. Create a matrix of known threats and monitor data and surveillance video feeds for pattern recognition match.
Use Case: Logic Fusion—Business TRIZ Problem Solver. Create a pattern driven master hub allowing for constraint business problem resolution informed by internal and external to the organization data.
Use Case: Business Management (variation of the Business TRIZ Problem Solver). Manage analysis and decisions of business patterns defined in a public hub containing domain specific solutions, informed by external to the organization public data. Private instances of the Public Hub are then created for each specific Organizational instance, allowing private to the Organization data to be added into the analysis and decision processes.
Case Study: Knowledge Fusion—Self-learning Knowledge Repository. Create self learning ontology based knowledge repository of what an employee knows and what the organization knowledge base knows.
Case Study: Financial industry (stock trading). Create a matrix of known factors influencing stock fluctuation (financial, political, environment-related events). Offer a service where individual traders and brokerage firms can get access to the filtered data using a subscription model.
Case Study: Internal Revenue Service. Create a messaging service to service state health exchanges income verification (using SSNs) as part of the healthcare reform.
Case Study: Appliance servicing intelligence community. Face recognition from image (including images stored in social networks), video feeds while sending/receiving data from portable devices (tablets, Google glass, blackberries).
Case Study: Retail industry. Collect and sort based on pre-defined semantic model that categorizes multi-vendor pricing to allow context sensitive price check on the best price offered by multiple vendors—target consumers, Amazon.
Use Case: Investigation, PDs, Criminology. Create a matrix of evidence types mapped to geolocation, criminology, prison systems databases. Offer as either self-hosted or subscription based service.
Use Case: Application Fusion Platform. Create platform for integrating application, logic and storage across distributed locations. Any application can be a plug-in into the Appliance Collective.
Use Care: Ontology-based Search Engine. Create Federated ontology-based search engine collective to answer business and science domain questions.

### Processing Architecture

This section describes architectural diagrams of a representative embodiment of the proposed invention.

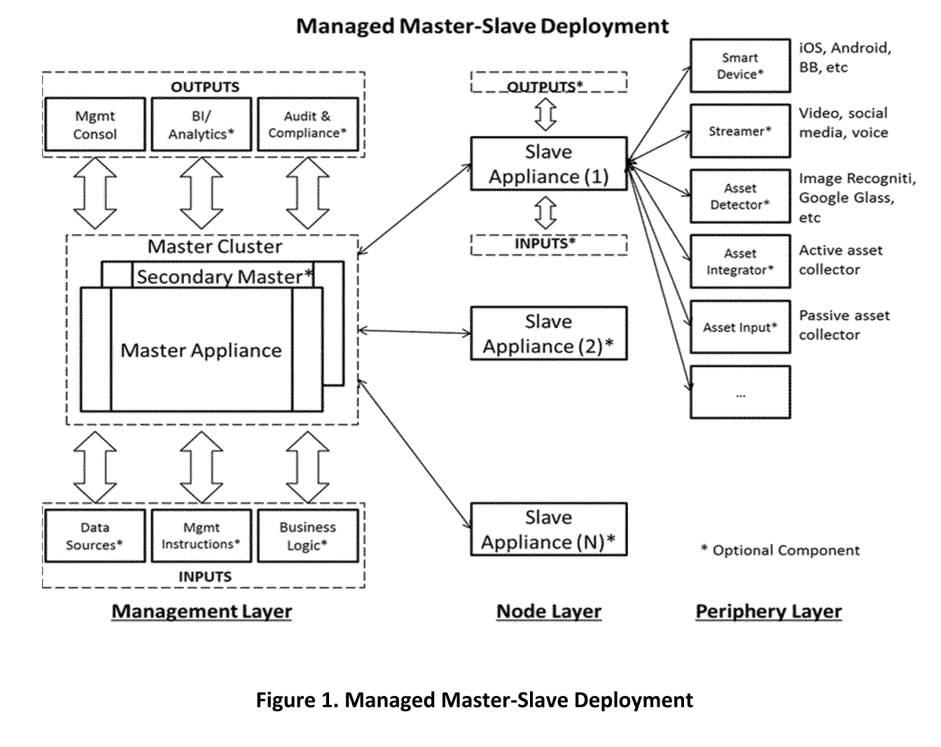

The deployment architecture diagram shown in FIG. 1 depicts managed master-slave deployment with a slave Appliance that collects data from Peripheral devices and submits it to the Master appliance for processing.

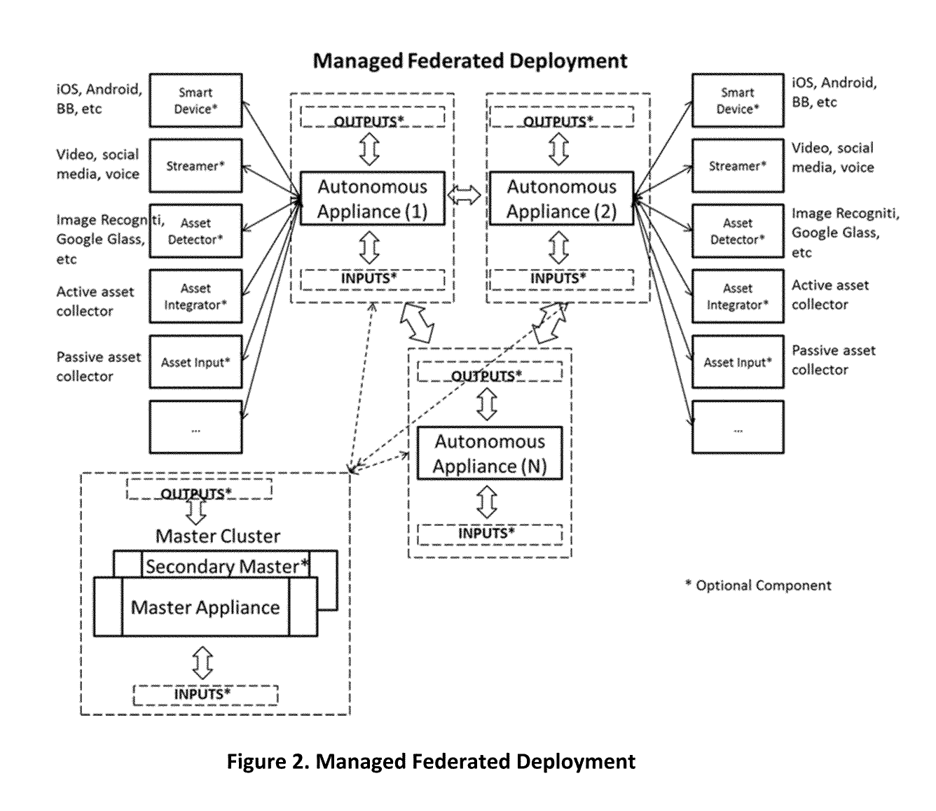

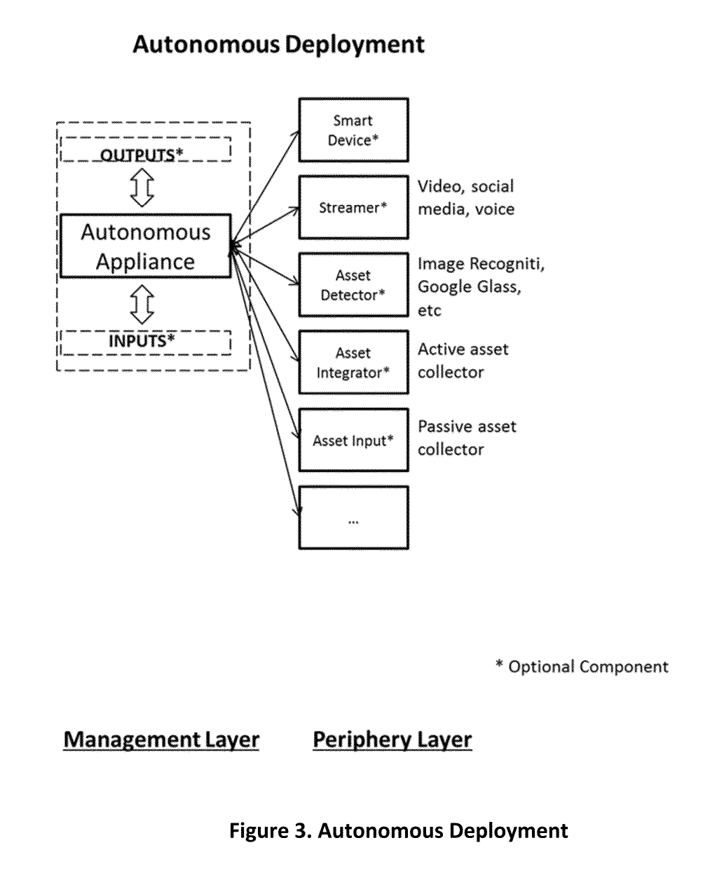

The deployment architecture shown in FIG. 2 depicts managed federated deployment where multiple Autonomous Appliances (see FIG. 3) collect data from peripheral devices. Collected data is federated and submitted to the Master appliance for processing.

The deployment architecture shown in FIG. 3 depicts Autonomous Appliance that collects data from multiple peripheral devices.

### Management Console

### Architecture

This section describes one representative embodiment of the architectural components of the Management Console.

### Technical Backbone and Infrastructure

Management Console can be installed on either physical or virtual hardware capable of running Linux operating system (as a representative example).

Architecture: x86, x86-64, IBM Power, IBM System Z
Storage support: FC, FCoE, iSCSI, NAS, SATA, SAS, SCSI
Network support: 10M/100M/1G/10G Ethernet, Infiniband

Technical Limits

| Architecture | CPU | Memory |
|---|---|---|
| x86 | 32 | 16 GB |
| x86_64 | 128/4096 | 2 TB/64 TB |
| Power | 128 | 2 TB |
| System z | 64 | 3 TB |

File Systems (max FS size)

| | |
|---|---|
| ext3 | 16 TB |
| ext4 | 16 TB |
| XFS | 100 TB |
| GFS2 | 100 TB |

### Processing Layers (HW. OS, Data Storage, Metadata, Application, Web)

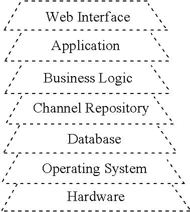

Management Console consists of the following processing layers:

Hardware—physical or virtual hardware

Operating System (OS)—collection of software that manages computer hardware resources and provides common services for computer programs

Database—stores appliance registration and configuration management-related data, as well as application specific data (e.g. SQL, non-SQL, Ontology)

Channel Repository—software package repository

Business Logic—core “business logic” and entry point for the collection of appliance supplied data through the use of agent software running on the appliance

Application(s)—collection and processing point for data collected from appliances; in some embodiments it can include content management system (CMS) capability

Web Interface—appliance registration, group, user, and channel management interface

Management Tools—database and file system synchronization tools, package importing tools, channel management, errata management, user management, appliance system and grouping tools

### Communication Interfaces

All communication between registered appliance(s) and Management Console takes place over secure internet connections. Management Console needs to allow inbound connections on ports 80 and 443 from registered and connected appliance(s). Monitoring functionality requires outbound connections to monitoring-enabled appliance(s), and push functionality requires both inbound and outbound connections. In one embodiment, the Management Console uses jabber (Extensible Messaging and Presence Protocol (XMPP) defined in RFC 3920 and 3921), osa (client-side service that responds to pings), and osa-dispatcher (server-side service that communicates with osa).

### Data Elements

The following data elements are defined in Management Console for initial configuration of an appliance:
Operating System
Hard Drive partitions
Locale
GPG and SSL keys
Software
Activation Keys
Pre and Post configuration scripts

The described above data elements describe the baseline configuration. Some embodiments may require additional data elements to be defined in order to adequately meet the set business objectives.

### CONOPS (Concept of Operations)

Management Console is a system-management platform that configures a physical (or virtual) appliance to a predefined known state. Once configured, Management Console manages the entire lifecycle of the appliance infrastructure including, but not limited to:
Secure, remote administration
Re-provisioning (re-provisioning is the act of reinstalling an existing system)
Updating software on the appliance or peripheral
Ensure updates, security fixes, and configuration files are applied across registered appliances consistently
Monitors operation and performance of appliances or peripheral

### Data Types and Feeds

Data Integration. The Data Integration layer in the Management Console has the ability to access, transmit, ingest, cleanse & enrich, aggregate, optimize, and present data for direct consumption at the Management console or integration with the Appliance device or Periphery. It has the ability to collect data from disparate sources such as databases (SQL or noSQL), knowledge systems (e.g. ontology, upper ontology, classification systems, concept maps, solution systems), sensors, OLAP, big data (e.g. HDFS), applications, web sources, geo-data, files (e.g. text, XML, XLS, image), streams (e.g. voice, video), file systems, generated data, and emerging data sources, and turn the data into a unified format that is accessible and relevant for direct or indirect use.

Common uses of the Management Console Data Integration include:
Data Storage (incl. load data from text files and store it into a database or Export data from database to text-file or more other databases)
Data migration between different data repositories and applications
Exploration of data in existing databases (tables, views, etc.)
Loading huge data sets into data repositories taking full advantage of cloud, clustered and massively parallel processing environments
Data Cleansing with steps ranging from very simple to very complex transformations
Data Integration including the ability to leverage real-time (Extraction, Transformation, and Loading) ETL as a data source
Data warehouse population with built-in support for slowly changing dimensions and surrogate key creation
Information improvement
Application integration
Report/dashboard data generation
Analytics

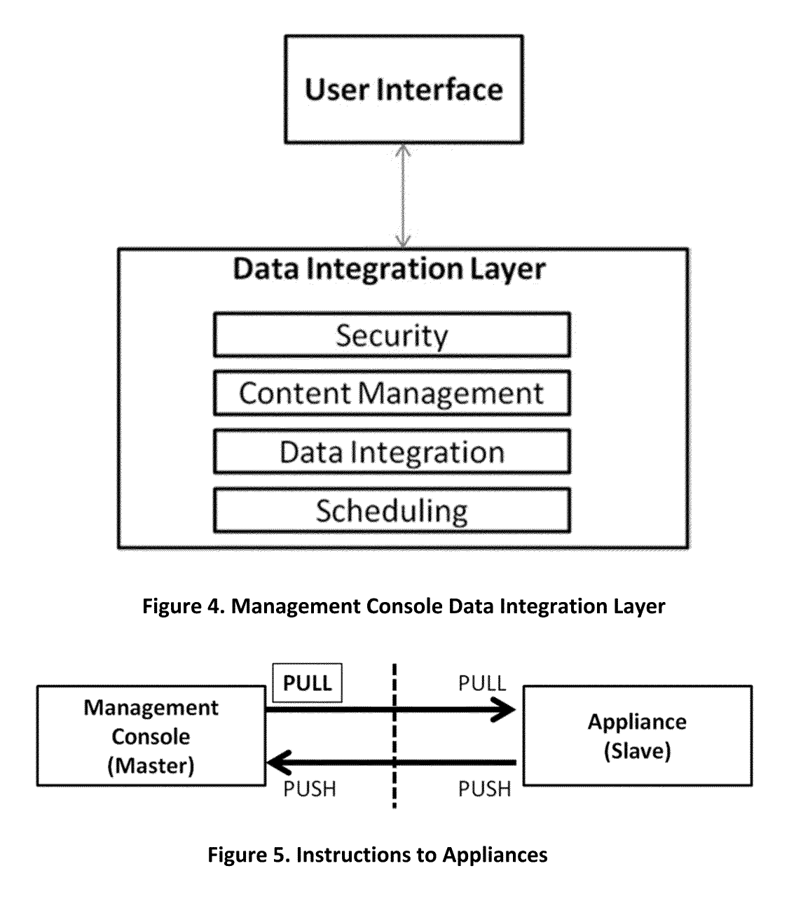

The architecture of the Management Console Data Integration layer is shown in FIG. 4.

Execution. Executes ETL jobs and transformations.

User Interface. Interface to manage ETL jobs and transformations, as well as licenses management, monitoring and controlling activity on Appliance data repository and analyzing performance trends of registered jobs and transformations.

Security. Management of users and roles (default security) or integration of security to existing security provider (e.g. LDAP or Active Directory).

Content Management. For all controlled Appliances and Peripheries, centralized repository for managing ETL jobs and transformations, full revision history on content, sharing/locking, processing rules, and metadata.

Scheduling. Service for schedule and monitor activities on data integration layer.

### Registration Process

Registration process occurs over Local Area Network (LAN) or Wide Area Network (WAN) using HTTP (port 80) or HTTPS (port 443) protocols. Process of registering a new appliance with Management Console (over LAN or WAN) comprises of:
Download Management Console's Trusted SSL certificate and bootstrap loader (in computing, a bootstrap loader is the first piece of code that runs when the machine starts, and is responsible for loading the rest of the operating system)
Execute the bootstrap loader.

### Channels and Sub Channels

A Management Console channel is a collection of software packages. Channels help segregate packages by rules: a channel may contain Operating System packages; a channel may contain packages for an application or family of applications. Channels can be grouped by particular need—for example, channel for server hardware, mobile devices, etc. All packages distributed through the Management Console have a digital signature. A digital signature is created with a unique private key and can be verified with the corresponding public key. Before the package is installed, the public key is used to verify the authenticity.

Operating System (OS) channels. These channels include base channels and child channels. A base channel consists of packages based on specific architecture and operating system release version; a child channel is a channel associated with a base channel that contains extra packages.

Software Channels. These channels manage custom application packages, including associated errata.When an Appliance is registered with Management Console, it is assigned to the base channel that corresponds to the system's version of Operating System. Once an Appliance is registered, its default base channel may be changed to a private base channel on a per-Appliance basis. Alternately, activation keys associated with a custom base channels can be used so that Appliances registering with those keys are automatically associated with the custom base channel.

Managing Software Errata. Errata Management enables exploration and addressing of published and unpublished errata data. Typical data includes details, channels, and packages. Errata alert notifications (e.g. emails) are available to administrators of subscribed systems, and generated when errata occurs in the system. Custom errata channels can be created and packages added. Once packages are assigned to an erratum, the errata cache is updated to reflect the changes. This update is delayed briefly so that users may finish editing an erratum before all of the changes are made available. Changes can also be initiated to the cache manually. Errata can be cloned as well.

### Configuration Management

Configuration management is referred to the working combination of Operating System and the required updates and snippets of hardening (distributed via the OS channel), combined with the all software applications and version (distributed via the Application channel). A controlled list of configurations will exist at any time across all registered appliances. The approved list of configurations are maintained at the Management Console and distributed via the subscription channels. At the start, the Operating System of the Appliance is reinstalled (initiated via the bootstrap script and via the OS Channel) which ensures that each Appliance is on a standard configuration.

Monitoring and Error handling

Monitoring. Management Console monitoring allows administrators to keep close watch on system resources, databases, services, and applications. Monitoring provides both real-time and historical state change information of the Management Console itself, as well as Appliances registered with the Management Console. There are two components to the monitoring system—monitoring daemon and monitoring scout. The monitoring daemon performs backend functions, such as storing monitoring data and acting on it; the monitoring scout runs on the appliance and collects monitoring data.

Monitoring allows advanced notifications to system administrators that warn of performance degradation before it becomes critical, as well as metrics data necessary to conduct capacity planning.

Monitoring allows establishing notification methods and monitoring scout thresholds, as well as reviewing status of monitoring scouts, and generating reports displaying historical data for an Appliance or service.

Error Handling. Management Console error handling collects application and web server access and error logs that occur on the management console. Monitoring scouts collect errors on the registered Appliance(s).

### Processing Chain—Instructions to Appliances (Pull Model)

Management Console can push reference or master data to the Appliance. The reference data carries contextual value and can be used to drive business logic that helps execute a business process or provide meaningful segmentation to analyze transactional data.

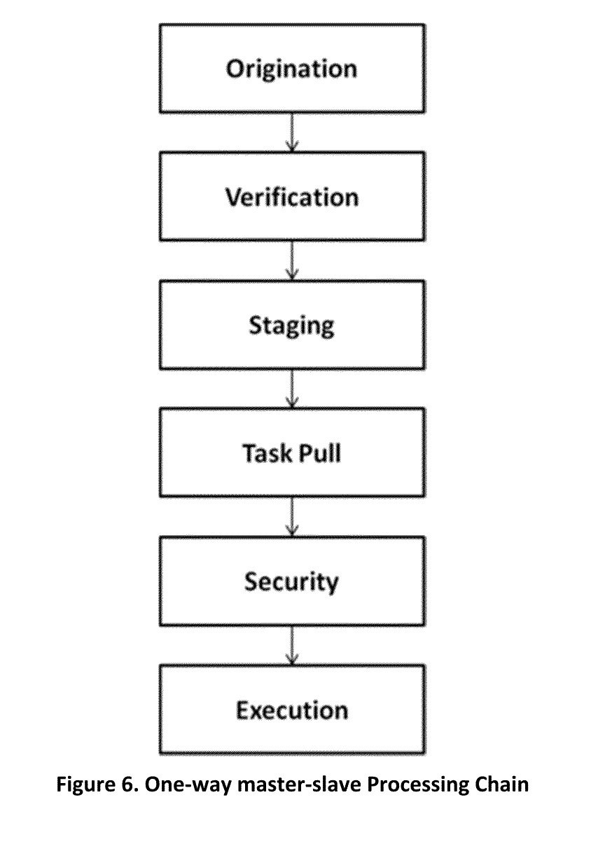

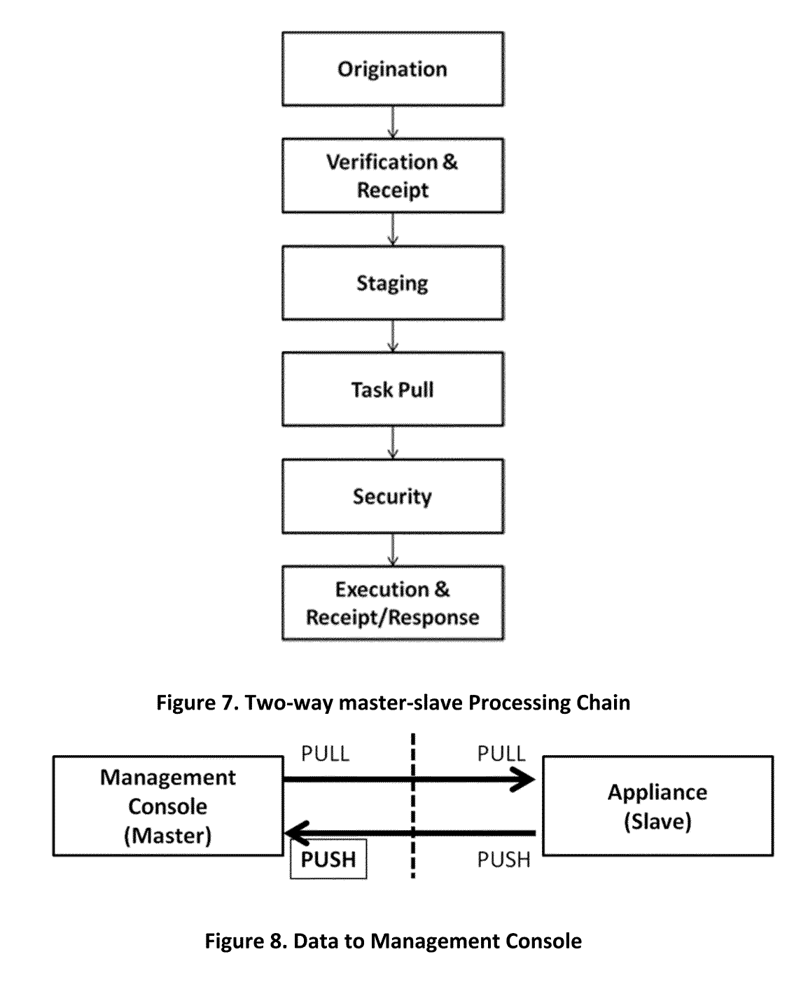

Processing Chain—Instructions to Appliances (PULL model). FIG. 5 describes the processing and transmission of instructions posted to Appliances (distributed slave nodes).
The master-slave interactions between the Management Console and the Appliances can be implemented in both one-way master-slave (OWMS) and two-way master-slave (TWMS) architectures. In one embodiment of OWMS architecture scenario, this processing chain is based on six steps: (1) origination, (2) verification, (3) staging, (4) task pull, (5) security, and (6) execution (FIG. 6).
In one embodiment of TWMS architecture scenario, this processing chain is based on six steps: (1) origination, (2) verification and receipt, (3) staging, (4) task pull, (5) security, and (6) execution and receipt/response (FIG. 7).
The Management console can remotely set the frequency of the Task Pull step in order to derive instruction execution and synchronization between the Appliance nodes. The Appliance can be configured to be able to define, as well as override or get the frequency setting from the Management Console.
   Processing Chain—Receiving and Processing data from Appliance (Push Model)

Processing Chain—Receiving and Processing Data from Appliance (PUSH model). FIG. 8 describes the processing and transmission of data posted to the Management Console Appliances.

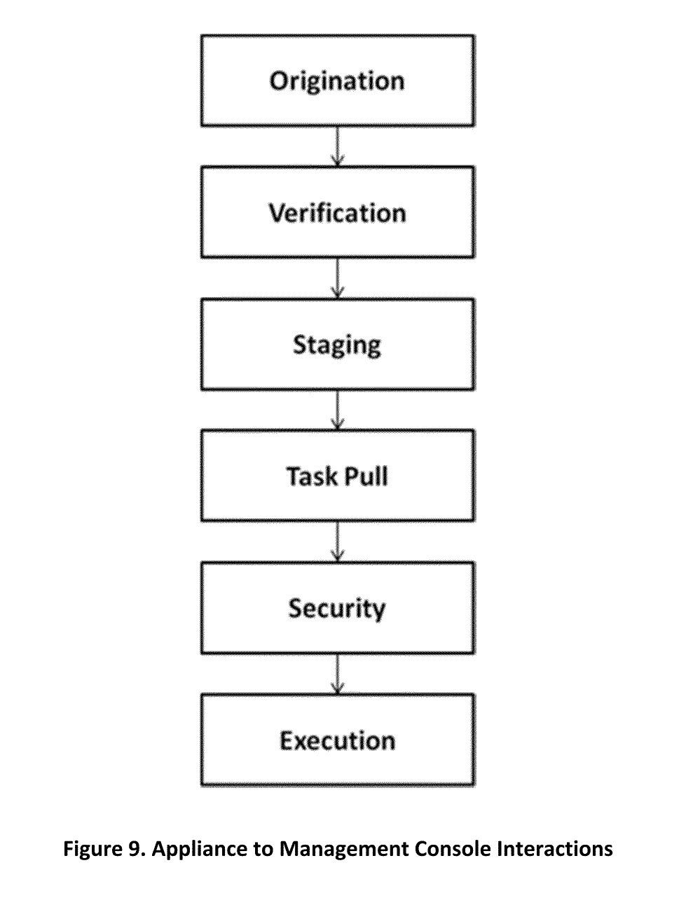

The master-slave interactions between the Appliance and the Management Console are only one way and it can trigger a PULL instruction to be generated from the Management Console to the Appliance. In one embodiment, this processing chain is based on six steps: (1) origination, (2) verification, (3) staging, (4) task pull, (5) security, and (6) execution (FIG. 9).
The Management console frequency of the Task Pull step can be set in order to derive instruction execution and synchronization between the Management Console and Appliance nodes.

### Users and Groups Management

User and User Group Management. Ability to create, activate, inactivate, and maintain users, user roles, user attributes (e.g. name, last sign), as well as groups of users. In one embodiment, responsibilities and access is designated to users through the assignment of roles. In one embodiment, roles can include:
User—standard role associated with any newly created user.
Activation Administrator—this role is designed to manage the collection of activation keys.
Channel Administrator—this role has complete access to managed, subscribe and create new channels and related associations.
Configuration Administrator—this role enables the user to manage the configuration of Appliances.
Monitoring Administrator—this role allows for the scheduling of test probes and oversight of other Monitoring infrastructure.
Administrator—this role can perform any function available, altering the privileges of all other accounts, as well as conduct any of the tasks available to the other roles.
System Group Administrator—this role is one step below Administrator in that it has complete authority over the systems and system groups to which it is granted access, including the ability to create new system groups, delete any assigned systems groups, add systems to groups, and manage user access to groups.

### Security

Communication, data and access:

Communications. All communications between the Management Console and Appliances are using encrypted communication protocols.

Data. Data stored at the Management Console, Appliance or periphery at still can be encrypted.

Access. Security access authentication can be done at the Management Console or based on a security provider (such as LDAP or Active Directory). Security at the Appliance is provided by the Management Console.

### Graphical User Interface (GUI)

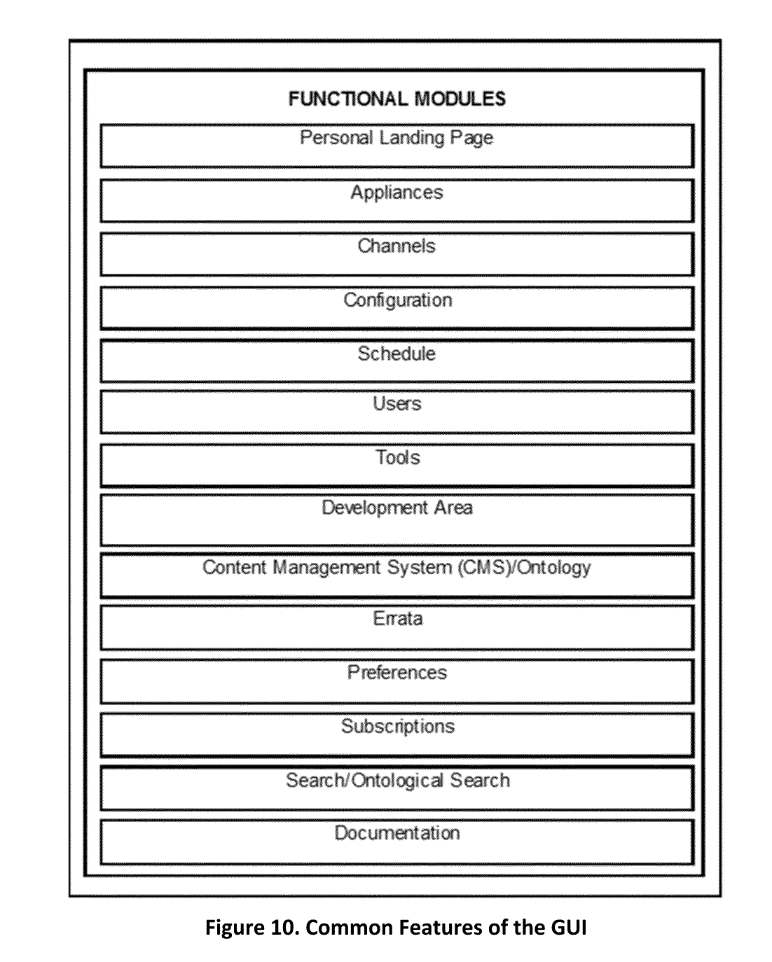

The GUI for the Management Console and the Appliances will have a similar look and feel. Certain functions and features will not be enabled and visible at the Appliance. In addition, based on access roles, users will see only the functionality that is available to them. FIG. 10 provides a snapshot of the features of the GUI of one representative embodiment.

### Content Management System/Ontology

A Content Management System (CMS) is a computer program that allows publishing, editing and modifying content as well as maintenance from a central interface. Such systems of content management provide procedures to manage workflow in a collaborative environment. In general, CMS stores and manages Metadata about data and can be in a relational format (e.g. SQL database) or non-relational format (e.g. Ontological data repository).

In computer science and information science, an ontology formally represents knowledge as a set of concepts within a domain, and the relationships between pairs of concepts. It can be used to model a domain and support reasoning about concepts.

In theory, an ontology is a “formal, explicit specification of a shared conceptualization”. An ontology provides a shared vocabulary, which can be used to model a knowledge domain, that is, the type of objects and/or concepts that exist, and their properties and relations.

Ontologies are the structural frameworks for organizing information and are used in artificial intelligence, the Semantic Web, systems engineering, software engineering, biomedical informatics, library science, enterprise bookmarking, and information architecture as a form of knowledge representation about the world or some part of it. The creation of domain ontologies is also fundamental to the definition and use of an enterprise architecture framework.

Ontologies share many structural similarities, regardless of the language in which they are expressed. Ontologies describe individuals (instances), classes (concepts), attributes, and relations. Common components of ontologies include:

Individuals: instances or objects (the basic or “ground level” objects)

Classes: sets, collections, concepts, classes in programming, types of objects, or kinds of things

Attributes: aspects, properties, features, characteristics, or parameters that objects (and classes) can have

Relations: ways in which classes and individuals can be related to one another

Function terms: complex structures formed from certain relations that can be used in place of an individual term in a statement

Restrictions: formally stated descriptions of what must be true in order for some assertion to be accepted as input

Rules: statements in the form of an if-then (antecedent-consequent) sentence that describe the logical inferences that can be drawn from an assertion in a particular form

Axioms: assertions (including rules) in a logical form that together comprise the overall theory that the ontology describes in its domain of application. This definition differs from that of “axioms” in generative grammar and formal logic. In those disciplines, axioms include only statements asserted as a priori knowledge. As used here, “axioms” also include the theory derived from axiomatic statements

Events: the changing of attributes or relations

Reasoning: helps produce software that allows computers to reason completely, or nearly completely, automatically.

In some embodiments, one can build ontology language upon Resource Description Framework (RDF). The RDF data model capture statements about resources in the form of subject-predicate-object expressions (or triples). RDF-based data model is more naturally suited to certain kinds of knowledge representation than the relational model and other ontological models.

### Search/Ontology Search

Keyword Search. Uses keywords and Boolean logic to retrieve information from a data repository.

SQL Search. Structure Query Language (SQL) as a mean to retrieve data form a structured database.

Ontology Search. It is common that the keyword-based search misses highly relevant data and returns a lot of irrelevant data, since the keyword-based search is ignorant of the type of resources that have been searched and the semantic relationships between the resources and keywords. In order to effectively retrieve the most relevant top-k resources in searching in the Semantic Web, some approaches include ranking models using the ontology which presents the meaning of resources and the relationships among them. This ensures effective and accurate data retrieval from the ontology data repository.

### Business Intelligence

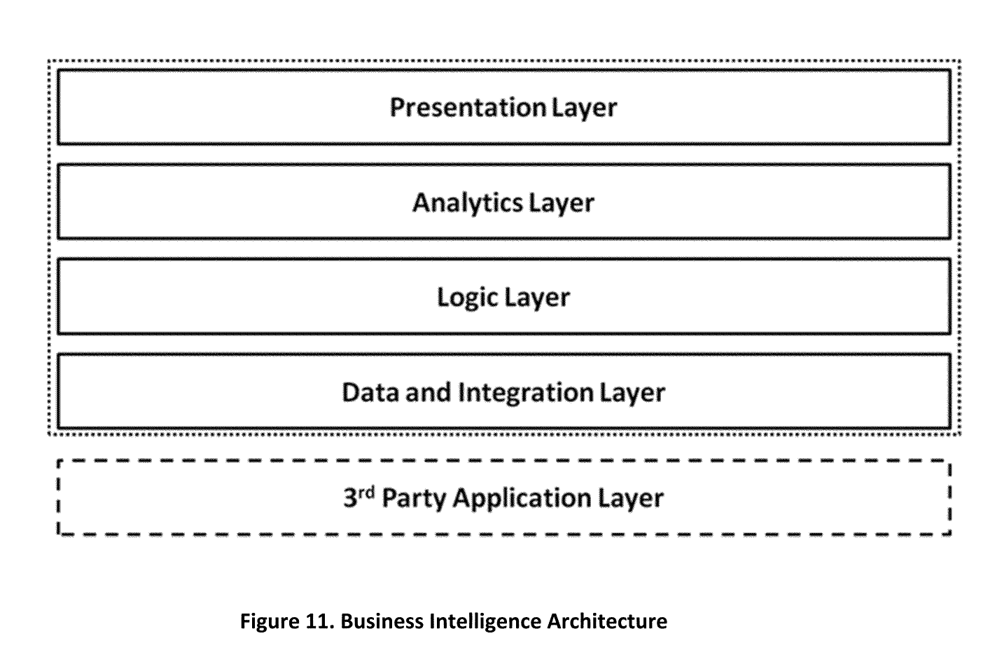

Business Intelligence (BI). The Business Intelligence layer is componentized, modular and scalable. The BI architecture is organized in five levels, as shown in FIG. 11.
Presentation Layer. Includes browser, portal, office, web service, email and other traditional or custom ways to present or display information.
Analytics Layer. Includes four sub layers:
   Reporting: Tactical, Operational, Strategic level reporting, which can be scheduled or ad-hoc.
   Analysis: Includes ability for Data Mining, OLAP, Drill & Explore, Model,
   Knowledge. Domain specific sub analysis layer is also available.
   Dashboards: Includes metrics, KPIs, Alerts, and Strategy and Action.
   Process Management: Includes integration, definition, execution, and discovery of processes, steps or sub-steps.
Logic Layer. Includes Security, Administration, Business Logic, and Content Management.
Data and Integration Layer. Includes ETL, Metadata, knowledge/ontology, EII]
3rd Party Application Layer. Includes ERP/CRM, Legacy Data, OLAP, Local Data, and Other Applications.

### Appliance

### Architecture

This section describes the common architectural components of the Appliances.

### Technical Backbone and Infrastructure

In one embodiment, an Appliance can run on either physical or virtual hardware capable of running Linux operating system.

Architecture: x86, x86-64

Network support: 10M/100M/1G/10G Ethernet

Technical Limits

| Architecture | CPU | Memory |
|---|---|---|
| x86 | 32 | 16 GB |
| x86_64 | 128/4096 | 2 TB/64 TB |

File Systems (max FS size)

| | |
|---|---|
| ext3 | 16 TB |
| ext4 | 16 TB |

### Processing Layers

Appliance processing layers include:

Hardware. In one embodiment, the Appliance runs a Linux operating system. More information on hardware compatible with Linux operating system can be found at

(http://wiki.centos.org/AdditionalResources/HardwareList)

Operating System. In one embodiment, CentOS or Red Hat can be used

Support Services. Support services include:
SFTP (Secure File Transfer Protocol)—transfer of reference and processed data
Scripting engine—scripts and script scheduling
Backup—backup and recovery of appliance applications and data
Directory Services (optional)—LDAP Directory services supporting peripherals authentication
File Management—management of incoming/outgoing reference data files and processed data
Monitoring Agent—monitors OS and applications health and submits data to Management Console
Management Console Agent—client program that connects to

Management Console and retrieves information associated with the queued actions for the appliance

Core Services. Core services include:
Data Repository—aggregates structured and unstructured data from internal and external data sources.
ETL—Extract, Transform, Load (ETL) tools to aggregate data
Data Matching—structures the wide variety of data and information
Rules Engine—machine learning and rules engine that uses its unique matching algorithms to identify, correlate and match data
Metadata—ontology metadata vocabulary (OMV), an extensible wrapper that is associated with each and every type of data or information that can contain the metadata about the data or information)
Ontology Engine—ontology consists of behavior patterns, contexts (topics, purpose, tasks, or matter that forms structures that represent processes, task structures or WBSs), preferences (defines context structures specific to an industry, e.g. pharma, intelligence, etc.), profiles (the elements of contexts that are meta-tagged by linking them across elements of definitional taxonomy—either folksonomy or controlled taxonomy), and identities of the data records (IDs)
Business Logic—used to apply logic to constantly growing data sets.
Administration—ongoing maintenance, health check, and performance tuning of the data cluster
Security—authentication and authorization

Application Services. Application services include:
Java Web Framework—Web application framework for creating and running java applications
Graphical User Interface (GUI)—Web-based user interface to allow import of reference data or access to processed data
Reports—Business analytics reports
Scheduling—Scheduling component that controls orchestration of application processes.

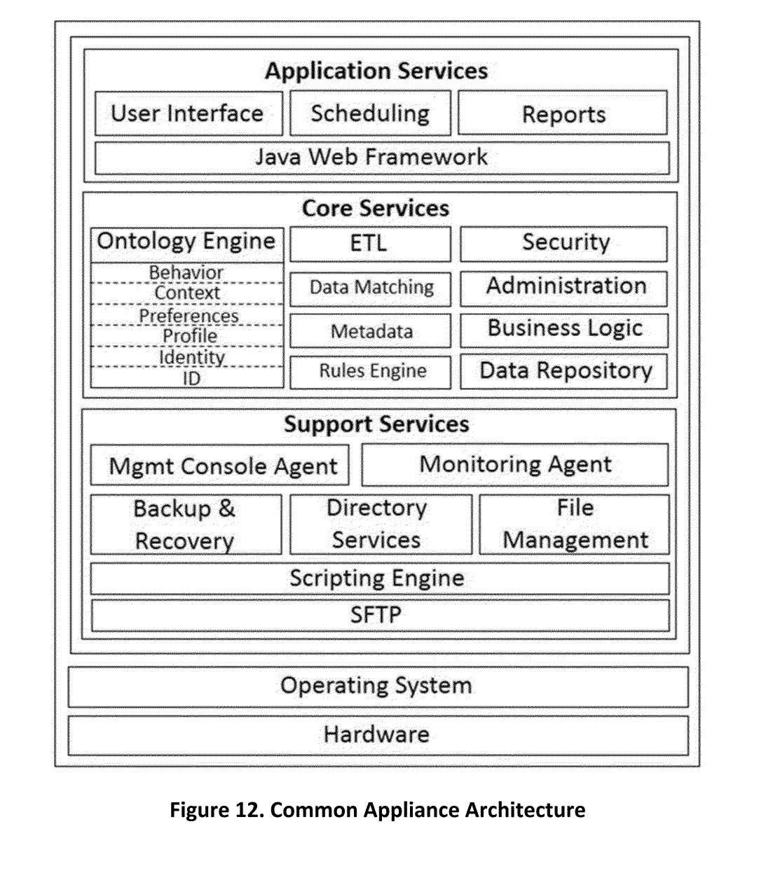

Appliance architecture is organized in three areas, as shown in FIG. 12.

### Communication Interfaces

Described at the Management Console section.

### Data Elements

Defined data elements will vary by industry; in some embodiments, data elements will include the following categories:
Reference Data—industry-specific data markers
Enterprise Data—HR, transactions, knowledge, E2O
Risk Management—regulatory compliance, fraud and incident prevention, credit and liquidity
Insights/Trends—Segmentation, trend analysis, sentiment analysis
Consumer Data—social, mobile

### CONOPS (Concept of Operations)

An appliance collects and processes data using reference data or data feeds from a peripheral. In one embodiment, the Appliance provides:
Secure, remote administration of peripherals connected to the appliance
Registration of management of peripherals
Ability to Update software on registered peripherals
Updates, security fixes, and configuration files are applied across registered peripherals consistently
Ability to Monitor operation of peripherals

Collected and processed data can be federated across multiple appliances and/or submitted to the Management Console.

### Data Types and Feeds

Data Integration. The Data Integration layer in the Appliance has the ability to access, transmit, ingest, cleanse & enrich, aggregate, optimize, and present data for direct consumption at the Appliance or integration with the Management Console or Periphery. It has the ability to collect data from disparate sources such as databases (SQL or noSQL), knowledge systems (e.g. ontology, upper ontology, classification systems, concept maps), OLAP, big data (e.g. HDFS), applications, web sources, geo-data, files (e.g. text, XML, XLS, image), streams (e.g. voice, video), file systems, generated data, and emerging data sources, and turn the data into a unified format that is accessible and relevant for direct or indirect use.

Common uses of the Appliance Data Integration layer include:
Data Storage (incl. load data from text files and store it into a database or Export data from database to text-file or more other databases)
Data migration among different data repositories and applications
Exploration of data in existing databases (tables, views, etc.)
Loading huge data sets into data repositories taking full advantage of cloud, clustered, and massively parallel processing environments
Data Cleansing with steps ranging from very simple to very complex transformations
Data Integration including the ability to leverage real-time (Extraction, Transformation, and Loading) ETL as a data source
Data warehouse population with built-in support for slowly changing dimensions and surrogate key creation
Information improvement
Application integration
Report/dashboard data generation
Analytics

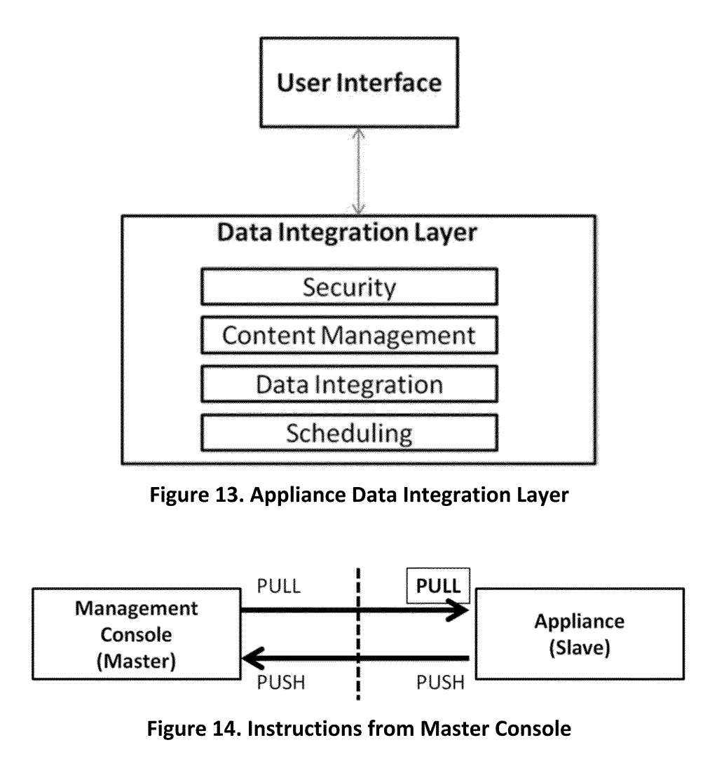

The architecture of the Appliance Data Integration layer is shown in FIG. 13.
Execution. Executes ETL jobs and transformations.
User Interface. Interface to manage ETL jobs and transformations, as well as licenses management, monitoring and controlling activity on this Appliance's data repository and analyzing performance trends of registered jobs and transformations.
Security. Integrates with the Security at the Management Console or manages users and roles (default security) or integrate security to existing security provider (e.g. LDAP or Active Directory).
Content Management. For the Appliance, centralized repository for managing ETL jobs and transformations, full revision history on content, sharing/locking, processing rules, and metadata.
Scheduling. Service for schedule and monitor activities on data integration layer.

### Initial Configuration and Independent Verification

Described at the Management Console section.

Monitoring and Error handling

Described at the Management Console section.

Processing Chain—Instructions from Master (Pull Model)

Processing Chain—Instructions from Master (PULL model). FIG. 14 describes the processing and transmission of data posted from the Management Console.

Processing Chain—Processing and Submitting data to Master (Push Model)

Processing Chain—Processing and Submitting data to Master (PUSH model).

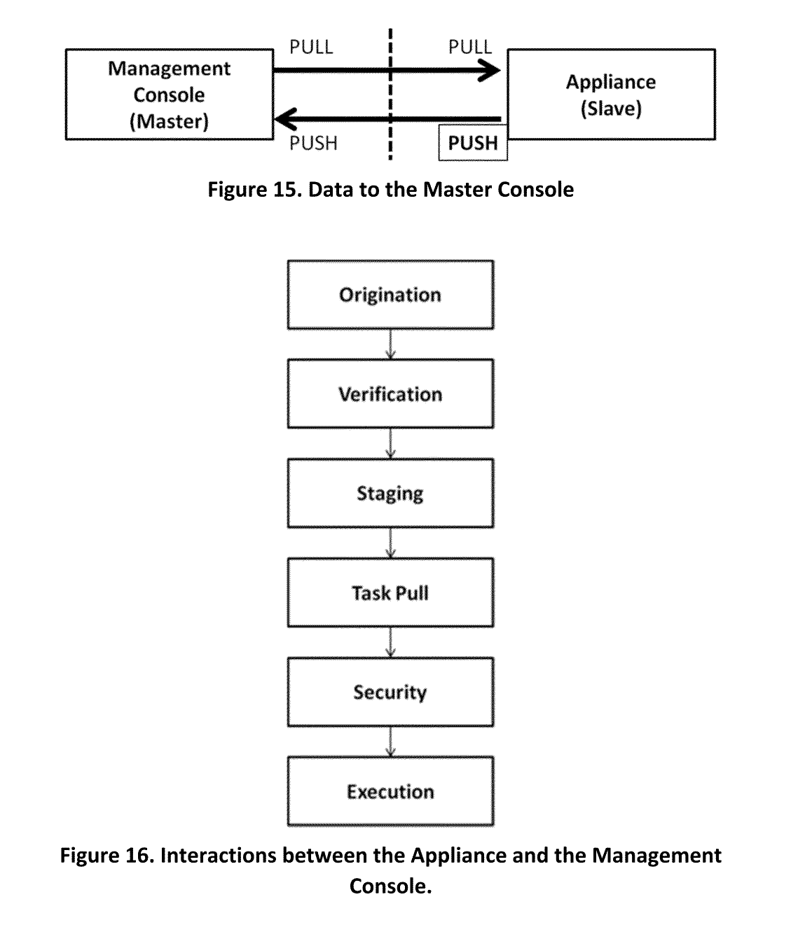

FIG. 15 describes the processing and transmission of data posted to the Management Console.

The master-slave interactions between the Appliance and the Management Console are only one way and it can trigger a PULL instruction to be generated from the Management Console to the Appliance. In one embodiment, this processing chain is based on six steps: (1) origination, (2) verification, (3) staging, (4) task pull, (5) security, and (6) execution (FIG. 16).

The Management console frequency of the Task Pull step can be set in order to derive instruction execution and synchronization between the Management Console and Appliance nodes.

### Users and Groups Management

Described at the Management Console section.

### Security

Described at the Management Console section.

### GUI/Front-End Tools

Graphical User Interface (GUI). Described at the Management Console section.

### Managing Peripherals

Managing Peripherals. Peripherals are managed by the Appliance and the Management Console in a similar way to how the Management Console manages Appliances (described above). Two channels are defined for each periphery type—Operating System (OS) Channel and Application Channel. The OS Channel is used for the distribution of the Operating System (if applicable) and the Application Channel is used for distribution of software and configuration data and information. In some scenarios, distributing a bootstrap script to replace the operating system of a periphery may not be desired. In such cases to ensure consistency across all connected peripheries, a requirement may be set for an OS version. Similarly to Appliances, Peripheries are registered in a secured way to the managing Appliance and the Management Console. The Management Console and managing Appliance GUI have the ability to manage status, configuration, communications, and send/receive instructions to each registered periphery.

### Processing Chain—Instructions to Peripheral (Push Model)

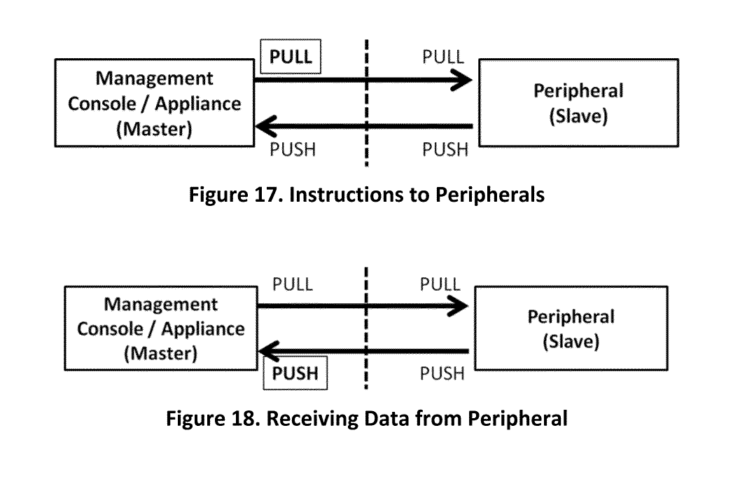

Processing Chain—Instructions to Peripheral (pull mode). This processing chain is similar to how the Management Console sends instructions to the Appliances. FIG. 17 illustrates the concept.

Processing Chain—Receiving and Processing data from peripheral (push model).

This processing chain is similar to how the Management Console receives instructions to the Appliances. FIG. 18 illustrates the concept.

### Business Intelligence (BI)

The Business Intelligence is based on the same concepts, features and functions as the Management Console.

### Peripherals

### Architecture

This section described the general architecture for peripherals.

### Technical Backbone and Infrastructure

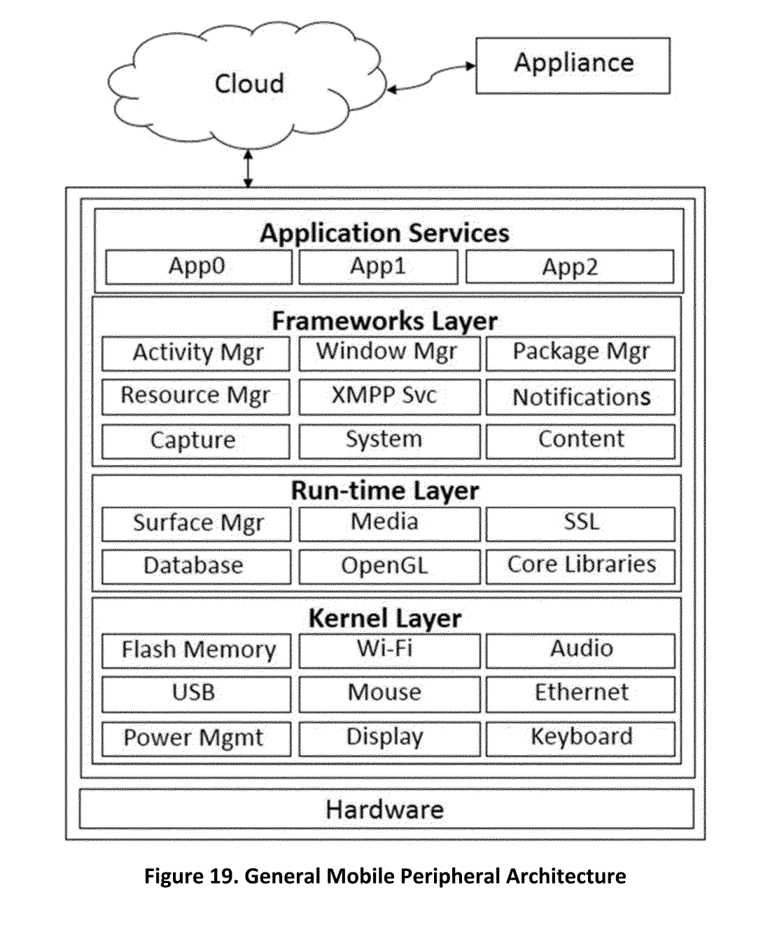

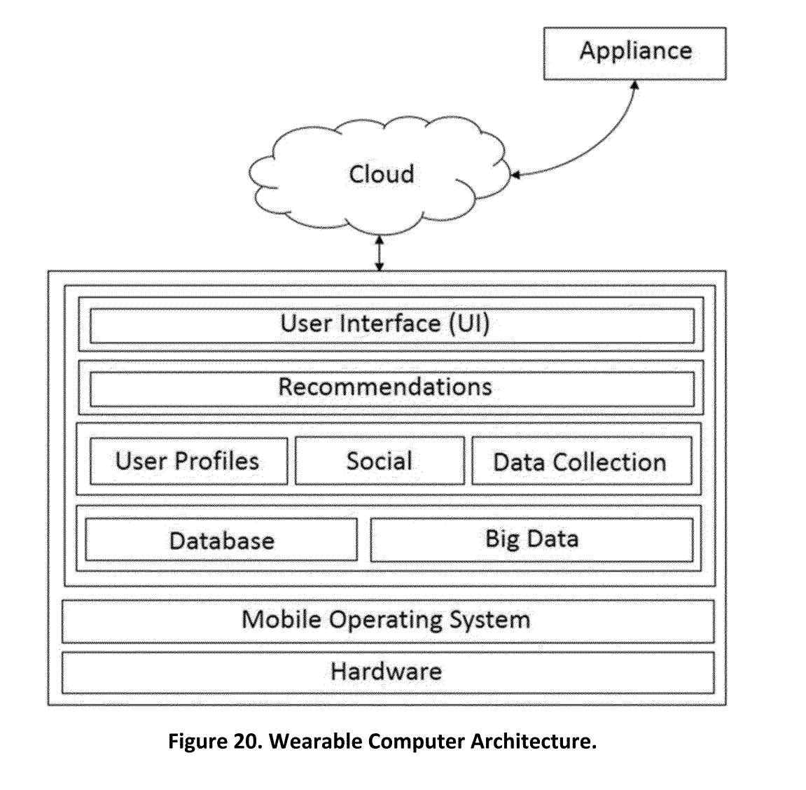

A peripheral can be a mobile device—Tablet or smartphone running mobile operating system and connected to an Appliance either directly or over Cloud. FIG. 19 illustrates the mobile peripheral architecture.
Peripheral can also be a wearable computer with a head-mounted display (HMD). FIG. 20 illustrates the wearable computer architecture.

### Supported Device Types

Sample list of supported devices include (but are not limited to)
Apple ® iPad, iPod, iPhone
Android Tablet, Mini-Tablet or Smartphone
Windows Mobile Tablet or Smartphone

### Processing Layers

Peripherals processing layers include:
Core OS layer—contains the low-level features that most other technologies are build upon
Kernel or Accelerate framework (depending on the OS)—contains display, image-processing, keyboard, Ethernet, USB, power management, audio, Wi-Fi, USB, Bluetooth and hardware accessories attached to the device
Runtime or System layer (depending on the OS)—contain low-level interfaces responsible for every aspect of the operating system like virtual memory, threads, file system, network, and interprocess communications. The drivers at this layer also provide the interface between available hardware and system frameworks.
Application frameworks layer—this layer defines the basic application infrastructure and support for key technologies such as multitasking, touch-based input, push notifications, and many high-level services.
Application services—this layer contains the application user interfaces.

### Communication Interfaces

Peripheral applications communicate with Appliance via HTTP, over variety of protocols such as:
GSM (UMTS/HSPA+/DC-HSDPA/GSM/LTE)
CDMA (CDMA EV-DO/UMTS/HSPA+/DC-HSDPA/LTE)
802.11a/b/g/n Wi-Fi
Bluetooth

### Data Elements

Defined data elements will vary by industry; in some embodiments, data elements include the following categories:
Reference Data—industry-specific data markers
Enterprise Data—HR, transactions, knowledge, E2O
Risk Management—regulatory compliance, fraud and incident prevention, credit and liquidity
Insights/Trends—Segmentation, trend analysis, sentiment analysis, analytics
Consumer Data—social, mobile

### Supported Peripheral Devices.

Peripheral devices are connected to a managing Appliance, Management Console or through an intermediary Cloud service via two channels—OS Channel and Application Channel. In the OS channel, it is possible that an entire operating system will be delivered, or just updates and hardening snippets, or no OS updates will be delivered at all.

The Peripheral devices have two main ways to connect to the managing Appliance or the Management Console: passive and active. Passive connection is when the managing Appliance or the Management Consol can manage the state, access, instructions and data looked for or collected of the peripheral through a management software which operates internally, or through an external management software. Examples of passive peripheral devices include remote camera, sensors, etc. In passive connections, typically no specialized software is needed to be installed to the peripheral device.

Active connection requires the Peripheral device to run a specialized Client application or application programming interface (API) connector which allows them to connect securely and interact with the Managing Appliance and/or the Management Console. Examples of active connection peripheral devices include mobile devices, applications, audio/visual devices (e.g. Google Glass), etc.

In some embodiments, the Client code for classes of peripheral devices, e.g. mobile devices (smart phone, tablets, etc), can be integrated using a mobile enterprise application platform (MEAP) development environment that provides tools and middleware for developing, testing, deploying and managing applications running on mobile devices. Using MEAP mobile middleware eliminates the need to re-write the Client applications for every operating system release and version, yet enabling Corporate App Stores/Markets to manage the distribution of the Client applications. It is also possible for MEAP to be used in conjunction with a mobile device management (MDM) platform.

### Technical Implementation

This section includes the main parts of the java processing code on the peripheral and the control center sides.

```
Appliance Satellite:
package com.recogniti.appl;
import java.util.ArrayList;
import java.util.Date;
import java.util.List;
import java.util.Map;
import redstone.xmlrpc.XmlRpcArray;
import redstone.xmlrpc.XmlRpcClient;
public class EdgeServerProvisioningProcessApiCall {
      public static final XmlRpcClient getXmlRpcClient( ) throws Exception {
            return new XmlRpcClient(Util.getProperty(RhnSateliteConstant.rpcApiUrl
                        .getValue( )), false);
      }
      public static final String getSessionKey(XmlRpcClient client)
                  throws Exception {
            final String userId = Util.getProperty(RhnSateliteConstant.userId
                        .getValue( ));
            final String passwd = Util.getProperty(RhnSateliteConstant.passwd
                        .getValue( ));
            List<String> params = new ArrayList<String>( );
            params.add(userId);
            params.add(passwd);
            String auth = (String) client.invoke(
                        RhnSateliteConstant.auth_login.getValue( ), params);
            return auth;
      }
      public static final Object invokeApi(XmlRpcClient client,
                  String sessionKey, String apiKey, Object... data) throws Exception {
            List<Object> params = new ArrayList<Object>( );
            params.add(sessionKey);
            for (Object obj : data) {
                  params.add(obj);
            }
            return client.invoke(apiKey, params);
      }
      public static final XmlRpcArray isEdgeServerRegistered(XmlRpcClient client,
                  String sessionKey, String serverName) throws Exception {
            // hostname
            Object ret = invokeApi(client, sessionKey,
                        RhnSateliteConstant.system_search_hostname.getValue( ),
                        serverName);
            if (ret != null && ret instanceof XmlRpcArray) {
                  XmlRpcArray arr = (XmlRpcArray) ret;
                  if (arr.size( ) > 0) {
                        return arr;
                  }
            }
            // ip address
            ret = invokeApi(client, sessionKey,
                        RhnSateliteConstant.system_search_ip.getValue( ), serverName);
            if (ret != null && ret instanceof XmlRpcArray) {
                  XmlRpcArray arr = (XmlRpcArray) ret;
                  if (arr.size( ) > 0) {
                        return arr;
                  }
            }
            return null;
      }
      public static final void systemgroup_create(XmlRpcClient client,
                  String sessionKey, String groupName, String groupDesc) {
            try {
                  invokeApi(client, sessionKey,
                              RhnSateliteConstant.systemgroup_create.getValue( ),
                              groupName, groupDesc);
            } catch (Exception e) {
                  System.err.println(e.getMessage( ));
            }
      }
      public static final String activationkey_create(XmlRpcClient client,
                  String sessionKey, String key, String desc, String serverName,
                  Integer usageLimit, String[ ] entitlements, Boolean universalDefault)
                  throws Exception {
            Object ret = invokeApi(client, sessionKey,
                        RhnSateliteConstant.activationkey_create.getValue( ), key, desc,
                        serverName, usageLimit, entitlements, universalDefault);
            return (String) ret;
      }
      public static final Object activationkey_enableConfigDeployment(
                  XmlRpcClient client, String sessionKey, String key)
                  throws Exception {
            Object ret = invokeApi(client, sessionKey,
                        RhnSateliteConstant.activationkey_enableConfigDeployment
                                    .getValue( ), key);
            return ret;
      }
      public static final Object activationkey_addConfigChannels(
                  XmlRpcClient client, String sessionKey, String[ ] key,
                  String[ ] configurationChannels, Boolean addToTop) throws Exception {
            Object ret = invokeApi(client, sessionKey,
      RhnSateliteConstant.activationkey_addConfigChannels.getValue( ),
                        key, configurationChannels, addToTop);
            return ret;
      }
      public static final Object activationkey_addChildChannels(
                  XmlRpcClient client, String sessionKey, String key,
                  String[ ] childChannelLabel) throws Exception {
            Object ret = invokeApi(client, sessionKey,
                        RhnSateliteConstant.activationkey_addChildChannels.getValue( ),
                        key, childChannelLabel);
            return ret;
      }
      public static final Object activationkey_addServerGroups(
                  XmlRpcClient client, String sessionKey, String key,
                  Integer serverGroupId) throws Exception {
            Object ret = invokeApi(client, sessionKey,
                        RhnSateliteConstant.activationkey_addServerGroups.getValue( ),
                        key, serverGroupId);
            return ret;
      }
      public static final Object kickstart_cloneProfile(XmlRpcClient client,
                  String sessionKey, String ksLabelToClone, String newKsLabel)
                  throws Exception {
            Object ret = invokeApi(client, sessionKey,
                        RhnSateliteConstant.kickstart_cloneProfile.getValue( ),
                        ksLabelToClone, newKsLabel);
            return ret;
      }
      public static final Object kickstart_profile_keys_addActivationKey(
                  XmlRpcClient client, String sessionKey, String ksLabel, String key)
                  throws Exception {
            Object ret = invokeApi(client, sessionKey,
                        RhnSateliteConstant.kickstart_profile_keys_addActivationKey
                                    .getValue( ), ksLabel, key);
            return ret;
      }
      public static final Object system_setCustomValues(XmlRpcClient client,
                  String sessionKey, Integer serverId,
                  Map<String, String> customLabelsToCustomValues) throws Exception {
            Object ret = invokeApi(client, sessionKey,
                        RhnSateliteConstant.system_setCustomValues.getValue( ),
                        customLabelsToCustomValues);
            return ret;
      }
      public static final Object system_custominfo_createKey(XmlRpcClient client,
                  String sessionKey, String keyLabel, String keyDescription)
                  throws Exception {
            Object ret = invokeApi(client, sessionKey,
                        RhnSateliteConstant.system_custominfo_createKey.getValue( ),
                        keyLabel, keyDescription);
            return ret;
      }
      public static final Object system_scheduleScriptRun(XmlRpcClient client,
                  String sessionKey, Integer serverId, String userName,
                  String groupName, Integer timeout, String script,
                  Date earliestOccurrence) throws Exception {
            Object ret = invokeApi(client, sessionKey,
                        RhnSateliteConstant.system_scheduleScriptRun.getValue( ),
                        serverId, userName, groupName, timeout, script,
                        earliestOccurrence);
            return ret;
      }
}
Utility:
package com.recogniti.appl;
import java.io.FileInputStream;
import java.util.Properties;
public class Util {
      private static final Properties PROPERTIES = new Properties( );
      static {
            loadProperties( );
      }
      public static final String getProperty(String key) {
            return PROPERTIES.getProperty(key);
      }
      private static final void loadProperties( ) {
            try {
                  String fileName = System
                              .getProperty(RhnSateliteConstant.properties_file_name
                                          .getValue( ));
                  if (fileName != null) {
                        try {
                              PROPERTIES.load(new FileInputStream(fileName));
                        } catch (Exception ex) {
                              ex.printStackTrace( );
                              try {
                                    PROPERTIES.load(new FileInputStream(
      RhnSateliteConstant.rhn_satelite_properties
                                                            .getValue( )));
                              } catch (Exception ex1) {
                                    ex1.printStackTrace( );
                              }
                        }
                  } else {
                        try {
                              PROPERTIES.load(new FileInputStream(
      RhnSateliteConstant.rhn_satelite_properties
                                                      .getValue( )));
                        } catch (Exception ex1) {
                              ex1.printStackTrace( );
                        }
                  }
            } catch (Exception ex) {
                  ex.printStackTrace( );
            }
      }
}
Constant:
package com.recogniti.appl;
public enum RhnSateliteConstant {
      rpcApiUrl(“rpcApiUrl”), userId(“userId”), passwd(“passwd”), rhn_satelite_properties(
                  “rhn-satelite.properties”), properties_file_name(
                  “properties_file_name”), auth_login(“auth.login”),
system_listUserSystems(
                  “system.listUserSystems”), name(“name”), system_search(
                  “system.search”), system_search_hostname(“system.search.hostname”),
system_search_ip(
                  “system.search.ip”), systemgroup_create(“systemgroup.create”),
activationkey_create(
                  “activationkey.create”), activationkey_enableConfigDeployment(
                  “activationkey.enableConfigDeployment”),
activationkey_addConfigChannels(
                  “activationkey.addConfigChannels”), activationkey_addChildChannels(
                  “activationkey.addChildChannels”), activationkey_addServerGroups(
                  “activationkey.addServerGroups”), kickstart_cloneProfile(
                  “kickstart.cloneProfile”), kickstart_profile_keys_addActivationKey(
                  “kickstart.profile.keys.addActivationKey”), system_setCustomValues(
                  “system.setCustomValues”), system_custominfo_createKey(
                  “system.custominfo.createKey”), system_scheduleScriptRun(
                  “system.scheduleScriptRun”), system_scheduleScriptRun_script(
                  “system.scheduleScriptRun.script”);
      private final String value;
      private RhnSateliteConstant(String value) {
            this.value = value;
      }
      public String getValue( ) {
            return value;
      }
}
```

### CONOPS (Concept of Operations)

Peripherals collect data using data capture device, streamer (video, social, media, and voice data), asset director (image recognition), asset integrator (active asset collector), and asset input (built-in camera, microphone, GPS, sensor). Once collected, data is sent to the Appliance for processing. Some of the processed and tagged data can be returned back to the peripheral device to be used as a reference data.

### Data Types, Feeds and Captures

Depending on the periphery device, compatible with the Management Console and Appliances data assets are supported.

### Registration and Initial Configuration.

The initial registration and configuration of peripheral devices follows a similar process to how Appliances register to the Management Console.

### Application Store

Referenced under mobile enterprise application platform (MEAP)

Processing Chain—Instructions from Appliance (Pull Model)

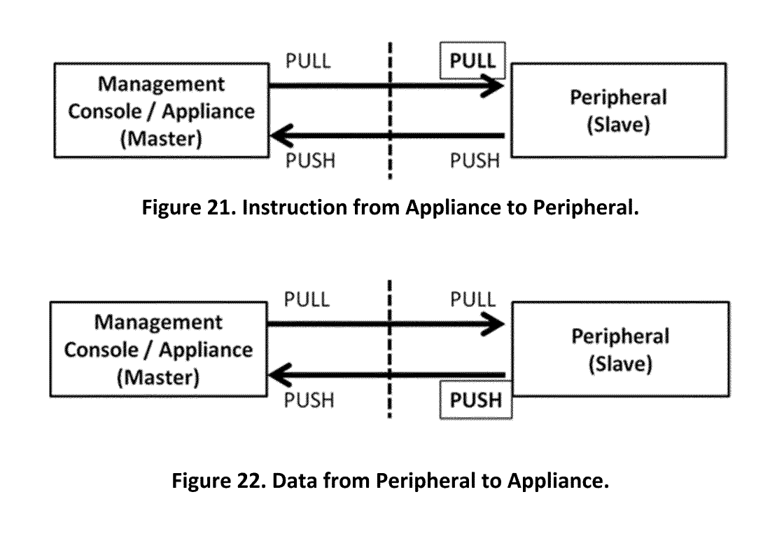

Processing Chain—Instructions from Appliance (pull model). This processing chain is similar to how the Management Console sends instructions to the Appliances. FIG. 21 illustrates the concept.

Processing Chain—Processing and Submitting data to Appliance (push model). This processing chain is similar to how the Management Console receives instructions from Appliances. FIG. 22 illustrates the concept.

### Security

Peripheral Security. Communications, data and access.

Communications. All communications between the Peripheral and Appliance (or

Management Console, if applicable) are using encrypted communication protocols (e.g. Transport Layer Security (TLS)/Secure Sockets Layer (SSL)) and requires a valid certificate.

Data. Data stored at the peripheral at still can be encrypted. In addition, the access to the peripheral device is code protected.

Access. Security access authentication can be done at the managing Appliance or the Management Console.

### GUI/Front-End/User Interface/App

Depending on the Peripheral device can have a look and feel that is specific to the type of peripheral (e.g. smart device, streaming camera, Google Glass, etc). The common functions that the Peripheral GUI/User Interface/App may have include: Input, processing logic, output, access/security, storage, visualization, analytics, and alerts.

### Data Fusion

Case Study: Intelligence community. Create a matrix of known threats and monitor data and surveillance video feeds for pattern recognition match. Intelligence analysis face a difficult task of analyzing volumes of information from variety of sources. Complex arguments are often necessary to establish credentials of evidence in terms of its relevance, credibility, and inferential weight. Establishing these three evidence credentials involves finding defensible and persuasive arguments to take into account. Data fusion solution helps an intelligence analyst cope with the many complexities of intelligence analysis. It uses a Management Console, an Appliance, Peripheral device, and active and passive data collectors. A peripheral device can be a smartphone, tablet or a wearable computer (like Google Glass). The peripheral device scans for face pattern recognition using reference data pushed by the appliance. Once a probable pattern match is identified, it forwards the information to the appliance that in turn does face recognition matching processed data against centralized data repository. In addition to the peripheral device, both active (video streams) and passive (video surveillance) data feeds are used to substantiate the pattern match. In one embodiment, at the Management Console, an ontology model performs symbolic probabilities for likelihood, based on standard estimative language, and a scoring system that utilize Bayesian intervals.

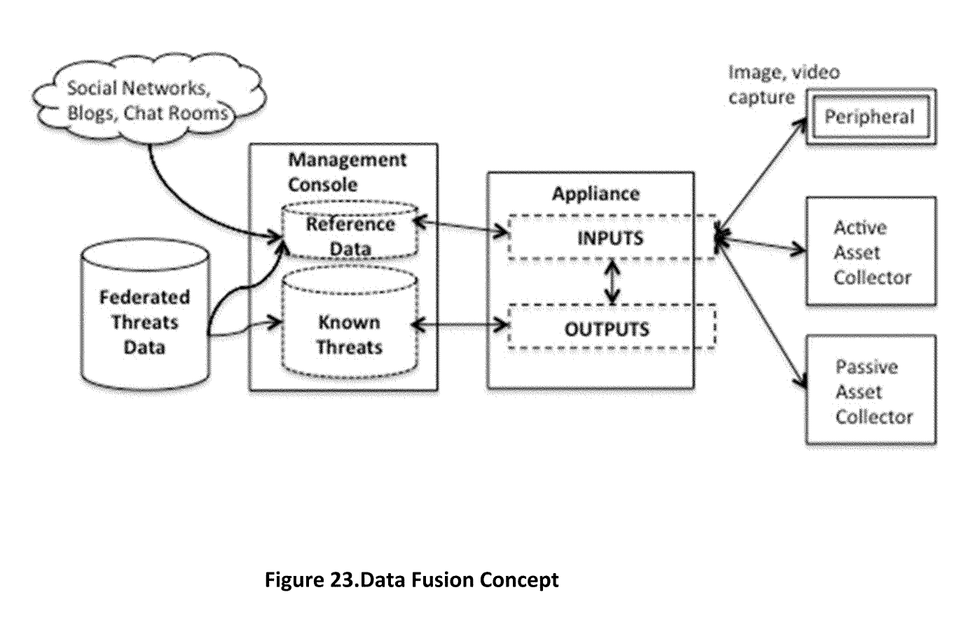

FIG. 23 illustrates

| Interval Name | Interval |
|---|---|
| almost certain | [0.8, 1.0] |
| likely | [0.6, 0.8] |
| even chance | [0.4, 0.6] |
| unlikely | [0.2, 0.4] |
| remote possibility | [0.0, 0.2] |
| no evidence | [0.0, 0.0] |

the Data Fusion concept.

### Logic Fusion

Use Case: Business TRIZ Problem Solver. Create a pattern driven master hub allowing for constraint business problem resolution informed by internal and external to the organization data. One of the core principals of business TRIZ: instead of directly jumping to solutions, TRIZ offers to analyze a problem, build its model, and apply a relevant pattern of a solution form the TRIZ pattern driven master hub to identify possible solution directions.

Problem Analysis>Specific Problem>Abstract Problem>Abstract Solution>Specific Solutions.

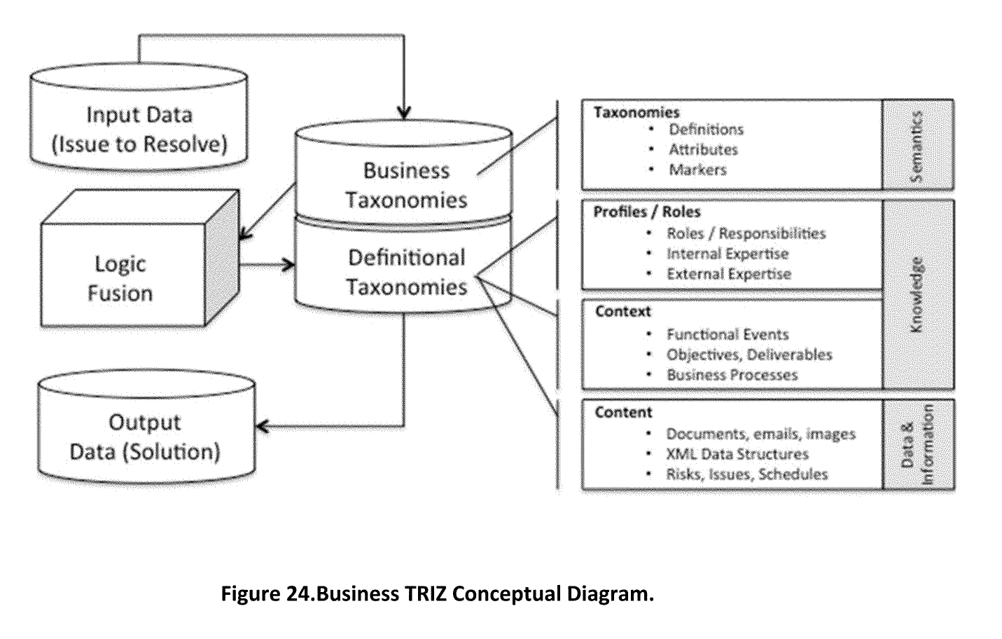

A business has a specific problem to address (Input Data); problem is then matched to business taxonomies that abstract the problem; abstract problem is then fed to the pattern driven master hub (Logic Fusion) that provides an abstract solution; Abstract solution is then mapped to Definitional Taxonomies that provide a specific solution. FIG. 24 illustrates the concept.

Problems in TRIZ terms are represented by a contradiction—“positive effect vs. negative effect”, where both effects appear as a result of a certain condition. Once a contradiction is identified, the next step is to solve it. The ideal solution is to address the contradiction by neither compromising nor optimizing it, but rather eliminate the contradiction in a “win-win” way.

Logic Fusion represents the contradiction matrix, which provides a systematic access to most relevant subset of inventive principals depending on the type of a contradiction.

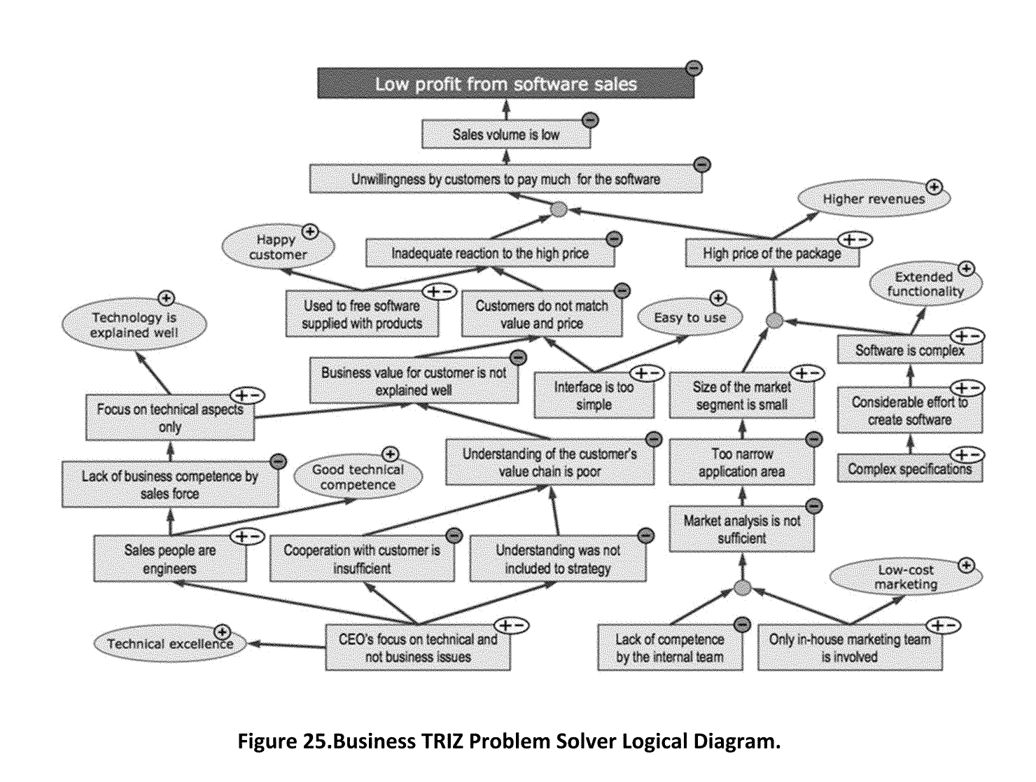

FIG. 25 illustrates finding an ideal solution to address a contradiction.

Use Case: Business Management (variation of the Business TRIZ Problem Solver).

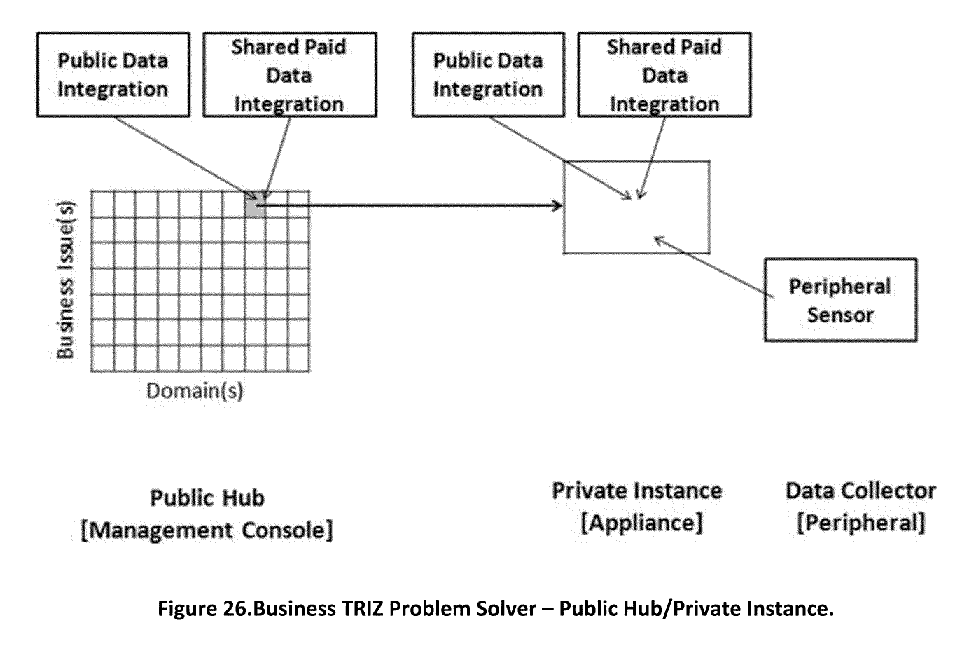

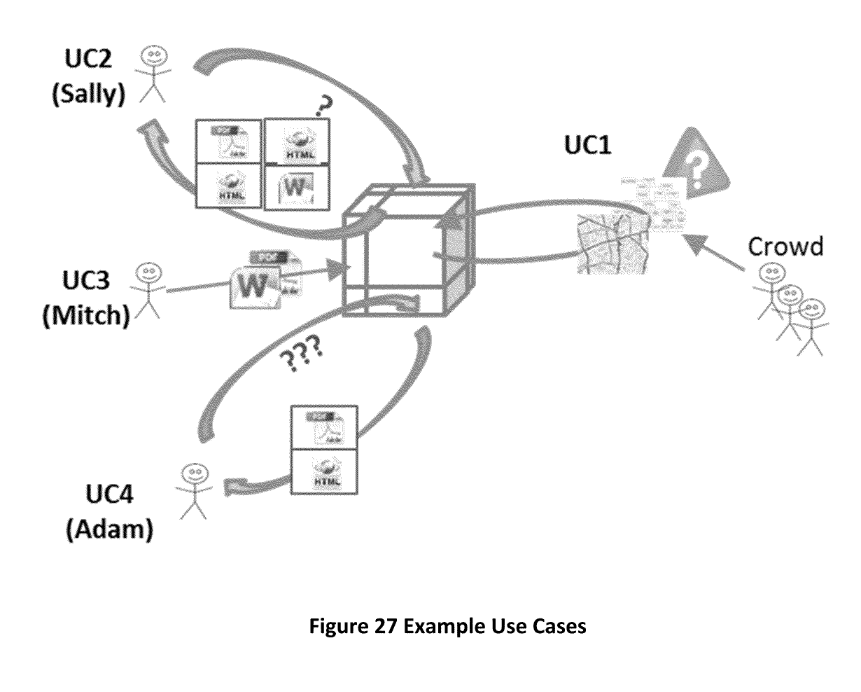

Manage analysis and decisions of business patterns defined in a public hub containing domain specific solutions, informed by external to the organization public data. Private instances of the public hub are then created for each specific Organizational purposes, allowing private to the Organization data to be added into the analysis and decisions processes. FIG. 26 illustrates the concept. For illustrative purposes, the Business issue is Risk Compliance. Domain 1 is Healthcare, domain 2 is Aviation Safety, domain 3 is manufacturing, . . . , domain 8 is financial services/lending, etc. Taking domain 8 as an example, the Public Hub will contain all requirements, TRIZ principles and domain solutions. The Private Instance of domain 8 for Bank of America (BofA) will contain BofA specifics. The Private Instance of domain 8 Wells Fargo will contain Wells Fargo specifics. In one embodiment, new compliance solution defined in the Wells Fargo

Private Instance, will be made available in analogous TRIZ terms to the Private Instance of domain 8 for BoA.

In one embodiment, the Public hub resides in the Management Console and is integrated with all external data sources (integrate data once, reuse multiple times).

Each Private instance resides in an Appliance where additional private to the organization data is integrated and protected from the Public Hub or other Private Instances. Based on configuration rules, data from the Private Instances can be integrated into the Public Hub or not. In one embodiment, the ontological patterns detected/defined in the Private Instance are sent and integrated into the Management Console. This enhances the analysis and decision ability for at the Public Hub and all Private Instances.

### Knowledge Fusion

Use Case: Self-learning Knowledge Repository. The objective of this use case is to set up a system to (1) improve information/knowledge retrieval and (2) improve information knowledge integration.

The system is referred to the collective of Management Console(s), Appliance(s) and Peripheral(s) with the goal to create self-learning ontology capturing what an individual actor (e.g. employee of an organization) knows and what the community (e.g. the corporation for which the employee is associated with) knowledge base is.
Improve information/knowledge retrieval. Knowledge fusion solution helps an individual actor to retrieve efficiently and precisely exactly the information needed, when needed, and in the format needed. The retrieval of the needed information and only the needed information is a complex challenge and requires deep understanding of the domain, the context, the content, the purpose, and the role/intent of the actor. For example, traditional search against an enterprise data repository (e.g. Knowledge Management System, Content Management System, or Learning Management System) often presents the challenge for the user to retrieve exactly what needed, especially when not clear to the user what they are looking for.
Improve information knowledge integration. Knowledge fusion helps all available information to be integrated into the ontological data repository for retrieval. This can happen passively (i.e. the actor submits information to the system) or actively (i.e. the system “scans” for available and relevant information and automatically integrates it.

Knowledge Fusion uses a Management Console, an Appliance, Peripheral device, and active and passive data collectors. A peripheral device can be a smartphone, tablet or a wearable computer (like Google Glass). The peripheral device scans the environment (e.g. a computer system, traffic of data, data repositories, or the real world) for relevant information using reference data pushed by the appliance. Once a probable pattern match is identified, it forwards the information to the appliance that in turn the Appliance does data integration into the localized ontological data repository. Some of the integrated data can be sensitive and needs to be “cleansed” before been integrated into the master ontological data repository stored on the Management Console. In some embodiments, in addition, the data collected in an Appliance may also require post processing before been integrated into the Management Console.

When a new concept or pattern is detected at the Management Console or at the Appliance, it is propagated into the entire system (i.e. all Appliances and Peripherals) for (1) ability for user to retrieve data based on the new pattern, and (2) ability for the system to detect relevant data and integrate it as available knowledge for future retrieval.

In one embodiment, the Knowledge Fusion system has five (5) sub use cases:
I know what I don't know and I know where it is. I can query the system for information. My challenge is information overload. The system helps refine the results of the query and only present the relevant information.
I know what I know. I can contribute my knowledge. The system integrates the information in a semi-automated fashion thus reducing the time it takes to build new knowledge base.
I don't know that such information exist, but I can benefit from it. The system finds it for me. Because of my “ignorance” my query doesn't have an answer, but the system determines what the “real” query should have been and returns the answer to that query.
I don't know what I know. I create content that can be used by others. The system automatically finds it and integrates it.
Activity and Anomaly Detection. The system automatically builds the knowledge base using my login information and the content of my queries.

### Example Practical Implementation

Let's consider an example where the Ontology-based Search Engine is used by an organization to maintain certificates in the knowledge areas of Service Oriented Architecture (SOA) and Cloud Computing. The goal of the organization is to set up the inventive system to: (A) improve information/knowledge integration; and (B) improve information/knowledge retrieval. For illustrative purposes, this example focuses on two knowledge topics: (1) Service Oriented Architecture (SOA) and (2) Cloud Computing.

The following use cases are considered (FIG. 6):
UC1. Traditionally, the organization doesn't have a systematic and automated way to data mine pertinent SOA and Cloud Computing information. This results in duplicate, inefficient effort and is subject to individual limitations and biases. The inventive system searches external SOA and Cloud Computing knowledge repositories, patent filings, scientific publications, product information, technical specifications, etc. and retrieves and integrates relevant knowledge into the organization's knowledge base.
UC2. Sally, expert in SOA with 10-years of experience, knows what she doesn't know and knows where to find it. This allows her to query the existing knowledge base for information. This traditionally has resulted in information overload. The present invention helps her refine the results of the query from the same knowledge base and only present the relevant information—exactly what she needs, when she needs it and in a readily accessible format.
UC3. Mitch, a published expert in the field with 25-years of experience, knows what he knows. He is familiar with what is relevant to others in the organization and contributes his knowledge regularly. Although he spends a considerable amount of time daily, this traditionally has resulted in little impact to the organization due to inability to consistently distribute and make readily accessible this knowledge. The present invention helps Mitch integrate his knowledge and make it readily accessible to Sally and all other users, when needed. The present invention can help Mitch accomplish this in two ways—fully-automated, when Mitch contributes knowledge to the organization's knowledge exchange and the inventive system integrates it automatically into the knowledge base, or semi-automated, when Mitch contributes knowledge to the inventive system by actively entering it into the knowledge base through the system interface. For illustrative purposes, only the fully automated way is addressed herein as the semi-automated way can be viewed as subset.
UC4. Adam, recent graduate and newest member of the organization with no experience, doesn't know what SOA and Cloud Computing information exists, but he (and the organization) will greatly benefit from it. Traditionally, new hires spend considerable amount of time in learning the sources and going through the content for knowledge and relevance to get ready for independent work assignments. The present invention helps Adam refine what his queries should be and makes all organizational knowledge available to Adam in a structured and systematically organized format—exactly what he needs, when he needs it and in a readily accessible format.

As an example of a practical implementation, first, an individual of the OntologyUniverse class is created (this is representing the ontology itself). Four subclasses of the LearningRequirementDimension class are created: NeedToKnow, Education, Experience. NeedToKnow has individuals Mandatory, CareerAdvancement, QuestForKnowledge. Education has individuals ES (elementary school), HS (high school), BS (bachelor's degree), MS (master's degree), PhD. Experience has individuals None, Some, Advanced, Expert. Each one of the five sample individuals of the class Requirement is characterized with three LearningRequirementDimension as shown in the Elements Created Table 1. Not all combinations of the values of the three LearningRequirementDimension are used:

TABLE 1

| Label | Elements Created |
|---|---|
| A | OntologyUniverse consistsOfRequirement |

Learning_Requirement_1
Learning_Requirement_2
Learning_Requirement_3
Learning_Requirement_4
Learning_Requirement_5

| | |
|---|---|
| B | LearningRequirementDimension |

NeedToKnow

Mandatory
CareerAdvancement
QuestForKnowelge

Education

ES
HS
BS
MS
PhD

Experience

None
Some
Advanced
Expert

| | | | |
|---|---|---|---|
| C | Learning_Requirement_1 | hasLearningRequirementDimension | Mandatory |

| | |
|---|---|
| hasLearningRequirementDimension | BS |
| hasLearningRequirementDimension | Some |

| | |
|---|---|
| Learning_Requirement_2 | hasLearningRequirementDimension |

CareerAdvancement

| | |
|---|---|
| hasLearningRequirementDimension | ES |
| hasLearningRequirementDimension | None |

| | | |
|---|---|---|
| Learning_Requirement_3 | hasLearningRequirementDimension | QuestForKnowelge |

| | |
|---|---|
| hasLearningRequirementDimension | BS |
| hasLearningRequirementDimension | Advanced |

| | | |
|---|---|---|
| Learning_Requirement_4 | hasLearningRequirementDimension | Mandatory |

| | |
|---|---|
| hasLearningRequirementDimension | ES |
| hasLearningRequirementDimension | Some |

| | |
|---|---|
| Learning_Requirement_5 | hasLearningRequirementDimension |

CareerAdvancement

| | |
|---|---|
| hasLearningRequirementDimension | MS |
| hasLearningRequirementDimension | Expert |

| | |
|---|---|
| E | Requirement Learning_Requirement_5 consistsOf |

CloudComputing_Certificate
SOA_Certificate

| | |
|---|---|
| G | Knowledge |

| | | |
|---|---|---|
| CloudComputing_Certificate | hasComponent | CloudHardware |
| CloudComputing_Certificate | hasComponent | CloudSoftware |
| CloudComputing_Certificate | hasComponent | CloudSupportTools |

| | |
|---|---|
| SOA_Certificate hasComponent | SOAP |
| SOA_Certificate hasComponent | WSDL |
| SOA_Certificate hasComponent | BPEL |

| | |
|---|---|
| H | ValueUnitType |

| | | |
|---|---|---|
| Time | aggregationType | Sum |

| | |
|---|---|
| measuringUnit | minutes |

| | |
|---|---|
| isOrdinal | true |
| isProgressive | true |

| | | |
|---|---|---|
| Precision | aggregationType | MAP (macro average precision) |

| | |
|---|---|
| measuringUnit | 1 |

| | | |
|---|---|---|
| | isOrdinal | true |
| | isProgressive | false |
| Recall | aggregationType | MAR (macro average recall) |

| | |
|---|---|
| measuringUnit | 1 |

| | |
|---|---|
| isOrdinal | true |
| isProgressive | false |

| | |
|---|---|
| I | ValueUnit |

| | | |
|---|---|---|
| CloudHardware_RetrievalTime | hasType | Time |

| | |
|---|---|
| hasValue | 0.3 |

| | | |
|---|---|---|
| CloudHardware_Precision | hasType | Precision |

| | |
|---|---|
| hasValue | 0.8 |

| | | |
|---|---|---|
| CloudHardware_Recall | hasType | Recall |

| | |
|---|---|
| hasValue | 0.9 |

| | | |
|---|---|---|
| CloudSoftware_RetrievalTime | hasType | Time |

| | |
|---|---|
| hasValue | 0.2 |

| | | |
|---|---|---|
| CloudSoftware_Precision | hasType | Precision |

| | |
|---|---|
| hasValue | 0.85 |

| | | |
|---|---|---|
| CloudSoftware_Recall | hasType | Recall |

| | |
|---|---|
| hasValue | 0.85 |

| | | |
|---|---|---|
| CloudSupportTools_RetrievalTime | hasType | Time |

| | |
|---|---|
| hasValue | 0.4 |

| | |
|---|---|
| CloudSupportTools_PrecisionhasType | Precision |

| | |
|---|---|
| hasValue | 0.75 |

| | | |
|---|---|---|
| CloudSupportTools_Recall | hasType | Recall |

| | |
|---|---|
| hasValue | 0.95 |

| | | |
|---|---|---|
| SOAP_RetrievalTime | hasType | Time |

| | | |
|---|---|---|
| | hasValue | 0.1 |
| SOAP_Precision | hasType | Precision |
| | hasValue | 0.9 |
| SOAP_Recall | hasType | Recall |
| | hasValue | 0.75 |

| | | |
|---|---|---|
| WSDL_RetrievalTime | hasType | Time |

| | | |
|---|---|---|
| | hasValue | 0.1 |
| WSDL_Precision | hasType | Precision |
| | hasValue | 0.8 |
| WSDL_Recall | hasType | Recall |
| | hasValue | 0.95 |

| | | |
|---|---|---|
| BPEL_RetrievalTime | hasType | Time |

| | | |
|---|---|---|
| | hasValue | 0.5 |
| BPEL_Precision | hasType | Precision |
| | hasValue | 0.95 |
| BPEL_Recall | hasType | Recall |
| | hasValue | 0.95 |

| | |
|---|---|
| J | Component |

| | | |
|---|---|---|
| CloudHardware | hasValueUnit | CloudHardware_RetrievalTime |

| | |
|---|---|
| hasValueUnit | CloudHardware_Precision |
| hasValueUnit | CloudHardware_Recall |

| | | |
|---|---|---|
| CloudSoftware | hasValueUnit | CloudSoftware_RetrievalTime |

| | |
|---|---|
| hasValueUnit | CloudSoftware_Precision |
| hasValueUnit | CloudSoftware_Recall |

| | | |
|---|---|---|
| CloudSupportTools | hasValueUnit | CloudSupportTools_RetrievalTime |

| | | |
|---|---|---|
| | hasValueUnit | CloudSupportTools_Precision |
| | hasValueUnit | CloudSupportTools_Recall |
| SOAP | hasValueUnit | SOAP_RetrievalTime |
| | hasValueUnit | SOAP_Precision |
| | hasValueUnit | SOAP_Recall |
| WSDL | hasValueUnit | WSDL_RetrievalTime |
| | hasValueUnit | WSDL_Precision |
| | hasValueUnit | WSDL_Recall |
| BPEL | hasValueUnit | BPEL_RetrievalTime |
| | hasValueUnit | BPEL_Precision |
| | hasValueUnit | BPEL_Recall |

From row E and on, the focus is on one Requirement: Learning_Requirement_{—}5.

Two individuals of the class Knowledge are identified. For each Knowledge, its Components are also identified as shown in Table 1 row G. Value Unit Types and Value Units are defined as shown in Table 1 rows H and I.

In this example, two responses are illustrated—EfficientReverselndexing (Resp1) and “DoubleRedundancy” (Resp2). The responses match the calls and improve information retrieval times. Table 2 Responses below defines the setup values.

TABLE 2

| Label | Elements Created |
|---|---|
| A | Capability subclassOf Dimension |

| | | |
|---|---|---|
| EfficientReverseIndexing | hasCost | $1 |
| DoubleRedundancy | hasCost | $1.5 |

| | |
|---|---|
| B | Component |

| | | |
|---|---|---|
| CloudHardware | hasValueUnit | CloudHardware_RetrievalTime |

| | | | |
|---|---|---|---|
| | | hasValueUnit | CloudHardware_RetrievalTime_Resp1 |
| | | hasValueUnit | CloudHardware_RetrievalTime_Resp2 |
| | | hasValueUnit | CloudHardware_RetrievalTime_Resp1&2 |
| C | ValueUnit | | |

| | | |
|---|---|---|
| CloudHardware_RetrievalTime_Resp1 | hasType | Time |

| | |
|---|---|
| hasValue | 0.2 |
| hasDimension | EfficientReverseIndexing |

| | | |
|---|---|---|
| CloudHardware_RetrievalTime_Resp2 | hasType | Time |

| | |
|---|---|
| hasValue | 0.1 |
| hasDimension | DoubleRedundancy |

| | | |
|---|---|---|
| CloudHardware_RetrievalTime_Resp1&2 | hasType | Time |

| | |
|---|---|
| hasValue | 0.08 |
| hasDimension | EfficientReverseIndexing |
| hasDimension | DoubleRedundancy |

Based on the created data elements (Table 1 and Table 2), the following values are computed (Table 3, Computed Values):

TABLE 3

| | Data | | | Formula |
|---|---|---|---|---|
| Label | Element | Element | Computed Value | used |
| D | Value Unit | CloudHardware_RetrievalTime | 0.291313 | A |
| | Criticality | CloudSoftware_RetrievalTime | 0.197375 | |
| | | CloudSupportTools_RetrievalTime | 0.379949 | |
| | | SOAP_RetrievalTime | 0.099668 | |
| | | WSDL_RetrievalTime | 0.099668 | |
| | | BPEL_RetrievalTime | 0.462117 | |
| | | CloudHardware_Precision | 0.33596323 | |
| | | CloudHardware_Recall | 0.28370213 | |
| | | CloudSoftware_Precision | 0.30893053 | |
| | | CloudSoftware_Recall | 0.30893053 | B |
| | | CloudSupportTools_Precision | 0.364851048 | |
| | | CloudSupportTools_Recall | 0.260216949 | |
| | | SOAP Precision | 0.28370213 | |
| | | SOAP_Recall | 0.364851048 | |
| | | WSDL_Precision | 0.33596323 | |
| | | WSDL_Recall | 0.260216949 | |
| | | BPEL_Precision | 0.260216949 | |
| | | BPEL_Recall | 0.260216949 | |
| | Knowledge | CloudComputing_Certificate | 2.731231417 | D |
| | Criticality | SOA_Certificate | 2.426620255 | |
| | Call | Learning_Requirement_5 Cr | 5.157852 | E |
| | Criticality | | | |

| | | | |
|---|---|---|---|
| Call | 1. | Capability added: EfficientReverseIndexing | F |
| Criticality | | Effect: CloudHardware_RetrievalTime is replaced with | |
| with | | CloudHardware_RetrievalTime_Resp1 | |
| Response | | OldCriticality Cr = 5.157852 | |
| applied | | Change in Criticality of Learning_Requirement_5: | |
| | | NewCriticality = OldCriticality − | |
| | | Criticality(CloudHardware_RetrievalTime) + | |
| | | Criticality(CloudHardware_RetrievalTime_Resp1) = | |
| | | 5.157852 − 0.291312612 + 0.19737532 = 5.063914708 | |
| | | Ontology contains: | |
| | | Learning_Requirement_5 hasCriticality CrA; | |

| CrA hasCapabilityApplied EfficientReverseIndexing; | |
|---|---|
| CrA hasValue 5.063914708 | |
| Learning_Requirement_5 CrA | 5.063914708 |

| | |
|---|---|
| 2. | Capability added: DoubleRedundancy |
| | Effect: CloudHardware_RetrievalTime is replaced with |
| | CloudHardware_RetrievalTime_Resp2 |
| | Change in Criticality of Learning_Requirement_5: |
| | NewCriticality = OldCriticality − |
| | Criticality(CloudHardware_RetrievalTime) + |
| | Criticality(CloudHardware_RetrievalTime_Resp) = |
| | 5.157852 − 0.291312612 + 0.099667995 = 4.966207383 |
| | Ontology contains: |
| | Learning_Requirement_5 hasCriticality CrB; |

| CrB hasCapabilityApplied DoubleRedundancy; | |
|---|---|
| CrB hasValue 4.966207383 | |
| Learning_Requirement_5 | 4.966207383 |
| CrB | |

| | | | |
|---|---|---|---|
| Effectiveness | 1. | EfficientReverseIndexing hasEffectivenessIndex EI_A | G |
| Index | | EI_A asAppliedTo Learning_Requirement_5 | |
| | | EI_A hasIndexValue 0.492308 (5.157852 − 5.063914708 = | |
| | | 0.093937292) | |

| | |
|---|---|
| EfficientReverseIndexing | 0.093937292 |

| | |
|---|---|
| 2. | DoubleRedundancy hasEffectivenessIndex EI_B |
| | EI_B asAppliedTo Learning_Requirement_5 |
| | EI_B hasIndexValue 0.58308 (5.157852 − 4.966207383 = |
| | 0.191644617) |

| | |
|---|---|
| DoubleRedundancy | 0.191644617 |

| | | | |
|---|---|---|---|
| Efficiency | 1. | EfficientReverseIndexing hasEfficiencyIndex FI_A | H |
| Index | | FI_A asAppliedTo Learning_Requirement_5 | |
| | | FI_A hasIndexValue 0.093937292 (0.093937292/$1) | |

| | |
|---|---|
| EfficientReverseIndexing | 0.093937292 (1/$) |

| | |
|---|---|
| 2. | DoubleRedundancy hasEfficiencyIndex FI_B |
| | FI_B asAppliedTo Learning_Requirement_5 |
| | EI_B hasIndexValue 0.127763078 (0.191644617/$1.5) |

| | | | |
|---|---|---|---|
| | DoubleRedundancy | 0.127763078 (1/$) | |
| Requirement | Learning_Requirement_5 | 0.127763078 (1/$) | I |
| Index | | | |

In a recomputed values, label “XSD” of the Component SOAP was added to the ontology. As a result, the precision of information retrieval precision and recall for this component went up from:

| | | |
|---|---|---|
| SOAP_Precision | hasValue | 0.9 |
| SOAP_Recall | hasValue | 0.75 |

to:

| | | |
|---|---|---|
| SOAP_Precision | hasValue | 0.95 |
| SOAP_Recall | hasValue | 0.80 |

This leads to the following changes in the Criticality of the corresponding Components, Knowledge and Call (Table 4):

TABLE 4

| Element | | Old | New | |
|---|---|---|---|---|
| Type | Element | Criticality | Criticality | Equation |
| Component | SOAP_Precision hasCriticality | 0.28370213 | 0.260216949 | B |
| Component | SOAP_Recall hasCriticality | 0.364851048 | 0.33596323 | B |
| Knowledge | SOA_Certificate hasCriticality | 2.426620255 | 2.374247256 | C |
| Call | Learning_Requirement_5 | 5.157852 | 5.105479001 | F |
| | hasCriticality | | | |

### Recompute Values

Criticality is computed for individual value units, as well as knowledge and calls that are assigned to them.

A possible functional form for Individual Criticality (as a measure of importance) is

analytical function form for a progressive Value Unit (as a factor of measure), the corresponding individual Criticality is:

$${IndCr}_{P} ( x ) = \frac{exp ( x ) - exp ( - x )}{exp ( x ) + exp ( - x )} , \qquad A$$

for a progressive Value Unit and

$${IndCr}_{R} ( x ) = \frac{2 * exp ( - x )}{exp ( x ) + exp ( - x )} . \qquad B$$

for a regressive Value Unit.

The behavior of this family of curves represent the fact that the function is sensitive to changes in its argument in the vicinity of argument ˜1,i.e. for Value Units around their reference values. For values VU>>VU_{ref} or VU<<VU_{ref} Criticality is not sensitive to changes in VU.

If an existing Value Unit changes its value from Old VU to a new value NewVU the Criticality NewCr of the Knowledge is recomputed as follows:

NewCr(Knowldge)=Cr(Knowledge)−IndCr(OldVU|Knowledge)+IndCr(NewVU|Knowledge) C

For a Knowledge the combined Criticality Cr(Knowledge) possible ways to combine the individual criticalities are:

Cr(Knowledge)=ΣₐIndCr(VUₐ|Knowledge) D

For Requirements Req the combined Criticality Cr(Call) possible ways to combine the individual criticalities are:

$$Cr ( Req ) = {\sum }_{a} IndCr ( {VU}_{α} \vert Call ) \qquad E$$

If an existing value unit changes its value from Old VU to a new value NewVU the criticality NewCr of the requirement is recomputed as follows:

NewCr(Call)=Cr(Call)−IndCr(OldVU|Call)+IndCr(NewVU|Call) F

Effectiveness index EI (Resp, Call) of a capability Resp is computed as the difference between the criticality of the Call in the absence of the Response and the criticality of the Call when the Response is applied.

EI(Resp, Call)=Cr(Call)−Cr(Call, Resp) G

Criticality Cr(Call, Resp) is lower than Cr(Call) because value units in A3′are changed by application of the Response Resp.

Efficiency index FI(Resp, Call) of a response Resp measures the effectiveness index EI (Resp, Call) of the response over cost spent on the response:

$$FI ( Resp , Call ) = \frac{EI ( Resp , Call )}{Cost ( Call )} \qquad H$$

Here is the summation is over all call Call from the OntologyUniverse of the organization, and over all the Responses Resp that can be applied to each Call.

Call Index CI(Call) is defined as the maximum efficiency indexes of all the Responses applied against this Call.

$$CI ( Call ) = {max}_{Resp ( Call )} FI ( Resp , Call ) \qquad I$$

### Identity Clearinghouse

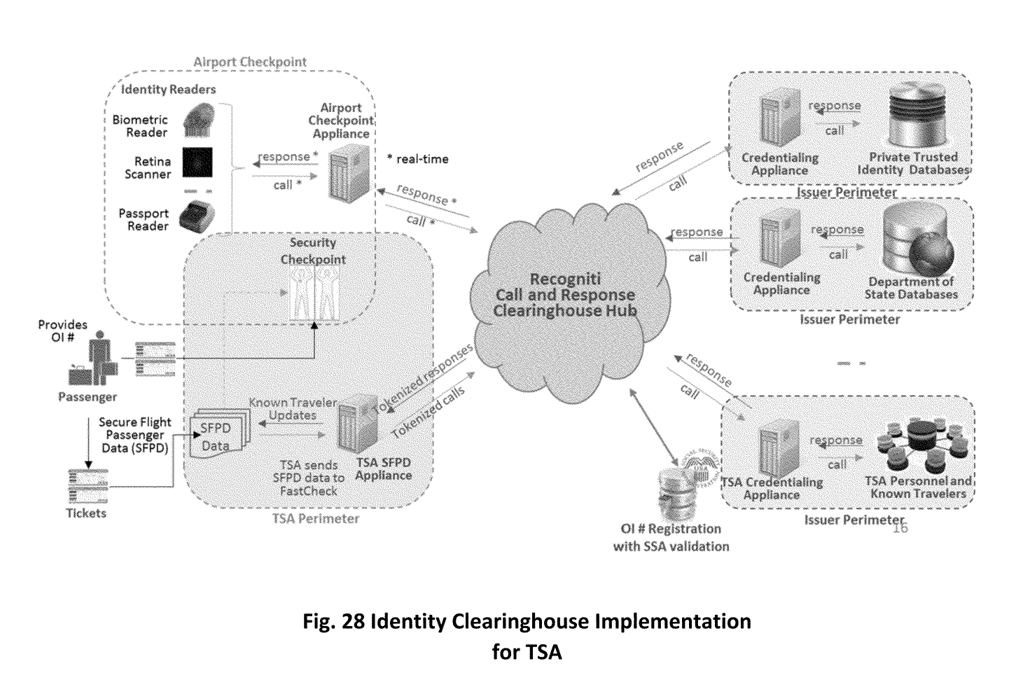

FIG. 28 depicts a functional architecture of the present invention deployed as an Identity Clearinghouse for the Transportation Security Agency (TSA) airport security. This implementation of the present invention is in conjunction with a secured identity Call and Response Clearinghouse implementation.

In this embodiment, the Clearinghouse Call and Response Hub acts as the Control Center for the collective of appliances. Passenger data is provided to TSA on regular intervals (days) prior to the flight date/time. Once the Secure Flight Passenger Data (SFPD) is received by TSA, in the same format it is sent to the TSA SFPD appliance which tokenizes the data into one message per passenger travel event. This constitutes the Calls. Each call is then sent from the TSA SFPD Appliance to the Control Center (i.e. the Call and Response Hub). Once received, each call is queued in the Clearinghouse Hub and two functions are performed: (1) passenger identity is determined, (2) new or existing call is determined, and (3) per business logic message(s) to one or more of the pre-approved by TSA trusted identity databases. If (1) is unsuccessful (meaning passenger identity cannot be confirmed, messages is sent back to the TSA with a passenger eligibility for pre-clearance=“No.”

The sent in (3) calls are received by the respective credentialing appliances, and passengers are checked against, for instance criminal databases, government security clearances, bio-bank, etc. Based on the pre-determined by TSA rules, passenger determination for pre-clearance eligibility is determined and sent as response back to the Call and Response Hub, and ultimately to the TSA SFPD appliance.

Below is the main code used in the clearinghouse processing.

1. A method for controlling or connecting a plurality of computer appliances in a networked control system, said method comprising the steps of:
i. providing a plurality of computer appliances comprising of processing steps for establishing an automated framework and technical devices for intelligent integration of two or more applications, logic rules, data repositories and/or services together to automate, manage, synchronize or monitor knowledge or business solutions in real-time;
ii. comprising of plurality of computer appliances for the said plurality of computer appliances;
iii. comprising of peripherals for computer appliances;
iv. the availability of said computer appliances or said peripherals capable of storing and/or processing structured or unstructured data;
v. providing a control center communicating with each appliance of said plurality computer appliances across a communication network;
vi. the control center determining when at least one of said plurality of computer appliances or peripheral will require maintenance or update;
vii. the control center determining the current inventory of plurality of computer appliances or peripherals for each controlled plurality of computer appliances
viii. the control center adding or reinitializing a new computer appliance;
ix. the control center adding or reinitializing a new peripheral;
x. the said computer appliance adding a peripheral;

2. The method of claim 1, where the said computer appliance is one of data processing system, data storage, data logic, data presentation, identity data, signaling, storage;

3. The method of claim 1, where the said structured or unstructured data is described with an ontology or other semantic methods;

4. The method of claim 1 further comprising the step of signaling an operator to the status of the control center or a computer appliance or peripheral, and the said signaling is one of monitor visible to the operator, information feed, alert, action trigger, message, report, analysis, dashboard.

5. The method of claim 1 wherein the said peripherals are composed of active and passive peripherals;

6. The method of claim 1, wherein the control center is further comprising of the following processing layers: web interface, application, business logic, channel repository, database, operating system, hardware;

7. The method of claim 1 where the said control center registering the said computer appliances and peripherals or the said computer appliance registers peripherals for the purposes of one or more of management, control, remote administration, re-registering, re-provisioning, updating software, ensuring updates/security fixes/configuration files are applied, monitors operation and performance;

8. The method of claim 1, wherein the said data originates from different sources and the said appliance is capable of (1) standardizing it and (2) relaying to the control center or other appliances;

9. The method of claim 1 wherein the said peripheral is comprised of steps for connecting to the said appliance directly or over a computer network;

10. A method for controlling a plurality of computer appliances in a networked control system, said method comprising the steps of:
i. providing clearinghouse processing (e.g. identity data);
ii. providing a plurality of computer appliances comprising of processing steps for establishing an automated framework and technical devices for intelligent integration of two or more applications, logic rules, data repositories and/or services together to automate, manage, synchronize or monitor knowledge or business solutions in real-time;
iii. comprising of plurality of computer appliances for the said plurality of computer appliances;
iv. comprising of peripherals for computer appliances;
v. the availability of said computer appliances or said peripherals capable of storing and/or processing structured or unstructured data;
vi. providing a control center communicating with each appliance of said plurality computer appliances across a communication network;
vii. the control center determining when at least one of said plurality of computer appliances or peripheral will require maintenance or update;
viii. the control center determining the current inventory of plurality of computer appliances or peripherals for each controlled plurality of computer appliances
ix. the control center adding or reinitializing a new computer appliance;
x. the control center adding or reinitializing a new peripheral;
xi. the said computer appliance adding a peripheral;

11. The method of claim 10 wherein the said clearinghouse is comprising of steps for handling one or more of knowledge, information or identity data;

12. The method for claim 10 wherein the said identity data is comprised of one of operator (who), location (where, from where), privileges (what) for the purposes of one of managing operator(s), authentication, authorization, privileges within a system;

13. The method for claim 10 wherein the said identity data is one or more of:
Active Directory, Service Providers, Identity Providers, Web Services, Access control, Digital Identities, Password Managers, Single Sign-on, Security Tokens, Security Token Services (STS), Workflows, OpeniD, WS-Security, WS-Trust, SAML 2.0, OAuth and RBAC;

14. The method for claim 10 wherein the said identity data is biometrics in nature and is one or more of fingerprint, palm veins, face recognition, DNA, palm print, hand geometry, iris recognition, retina and odor/scent, behavioral characteristics, typing rhythm, gait, and voice;

15. The method of claim 10, wherein the said clearinghouse is comprised of steps to determine authenticity, credibility or eligibility of an asset;

16. The method of claim 10 further comprising the step of signaling an operator to the status of the control center or a computer appliance or peripheral, and the said signaling is one of monitor visible to the operator, information feed, alert, action trigger, message, report, analysis, dashboard.

17. The method of claim 10, wherein the control center is further comprising of the following processing layers: web interface, application, business logic, channel repository, database, operating system, hardware;

18. The method of claim 10 where the said control center the said computer appliances and peripherals or the said computer appliance registers peripherals for the purposes of one or more of management, control, remote administration, re-registering, re-provisioning, updating software, ensuring updates/security fixes/configuration files are applied, monitors operation and performance;

19. The method of claim 10, wherein the said data originates from different sources and the said appliance is capable of (1) standardizing it and (2) relaying to the control center or, other appliances;

20. The method of claim 10 wherein the said peripheral is comprised of steps for connecting to the said appliance directly or over a computer network;
